(19) United States
(12) Patent Application Publication
(10) Pub. No.: US 2018/0197247 A1
(43) Pub. Date: Jul. 12, 2018

(54) Apparatus and Method for Fractional Bond Allocations

(71) Applicant: Douglas Lyon, Milford, CT (US)

(72) Inventor: Douglas Lyon, Milford, CT (US)

(21) Appl. No.: 15/850,583

(22) Filed: Dec. 21, 2017

Related U.S. Application Data
(63) Continuation-in-part of application No. 62/443,678, filed on Jan. 7, 2017.

(51) Int. Cl. G06Q 40/06; G06Q 40/04; G06Q 40/02; G06Q 30/06; G06Q 20/10

(52) U.S. Cl. CPC G06Q 40/06; G06Q 40/04; G06Q 20/10; G06Q 30/06; G06Q 40/02

(57) ABSTRACT

A Note-holder accessing a bond web site is provided an opportunity to have a bond purchase request wholly or partially satisfied by a financial institution at terms from the financial institution. The financial institution, for example, can receive information about a partial bond purchase request, determine whether to authorize a split of the bond, offer an apportioned fraction of the bond to the individual on terms determined by the financial institution, and issue the fractional bond to an investor responsive to approval of the terms. Prior to an auction, the investor can choose an immediate bond offer having financial institution terms or choose to solicit investor offers with more favorable terms through the company website. The financial institution can also offer a gap-filling fractional bond for a deficiency amount so that the bond request can be partially satisfied by investor offers.

### CLAIM TO PRIORITY

This application claims priority from U.S. Provisional Patent Application No. 62/443,678, filed on 7 Jan. 2017, which is incorporated by this reference for all that it discloses for all purposes.

### BACKGROUND

Fundamentally, a bond is a financial tool that can help a government or corporate entity raise money. A bond is basically a document that simply means “I owe you”. “I (a person or institution that owes a sum of money) owe you (the lender) X dollars and will pay you X dollars back as follows”. Thus, the term bond is defined as a debt instrument in which an investor loans money to an entity (person or institution) which borrows the funds for a defined period at a variable or fixed interest rate. The indebted entity (bond issuer) issues a bond that contractually states the interest rate (coupon) that will be paid and the time at which the loaned funds (bond principal) must be returned (maturity date). The amount of interest that is paid by the Note-holder is the “yield” so that a 10% bond has twice the yield as a 5% bond (all other things being equal). However, all bonds are not created equal. The market price of a bond depends on several factors including credit quality of the issuer, length of time until expiration, and coupon. A “junk bond”, for example, refers to high-yield or a non-investment-grade bond. Basically, for junk bonds, there is a high risk the bond issuer will not pay back the bond amount, but if such a bond issuer does pay back the debt, the bond-holder makes more profit compared to what safer investments pay. Thus, most investors typically put a cap/limit on the bond “yield” figure (say 10%) to limit risk of lending money to a “deadbeat” that does not pay back the money owed on the bond.

Increasingly prevalent, bond purchases enjoy significant favor by investors and positive feedback from financial advisors, but are subject to large minimums, low volumes, large spreads and an inefficient matching between investors and the bond market. Today, various fixed income specialists use websites to provide access to bonds that are for sale to investors, but none of them can subdivide the bonds and match the subdivisions to investor requests.

Thus, many investors do not get their bond purchase requests filled. First, bond purchase requests may far exceed bonds available. Second, some websites utilize group or affinity relationships, such as relationships with brokers or other websites, and investors with no group or affinity relationship, can have difficulty purchasing bonds. Third, investors also can make poorly thought-out or confusing bond requests, putting off individual bond brokers. Fourth, overly simplified bid-ask listings can result in bond investors being misled into thinking that they will have their bond purchases satisfied, only to have their requests cancelled. For example, one bond broker advertises that bids can be reduced by 1% below the ask price, however, after making such a bid, within an hour or two, you get a call indicating the order was canceled, the market has moved up and now you must raise the price to the ask. Check the price with other brokers does you no good, as the new ask price reflects the hidden markup price the broker imposes. Even if the company goes bankrupt and the bond is rendered worthless, the broker can rest assured that there are making their markup. And the spreads can be big. Consider Sears whose bonds were trading with a yield to maturity of between 35% and 25%. Traders who are used to making limit orders would naturally try to split the bid and ask price, bidding to obtain, perhaps, a 30% yield to maturity. However, in the bond market, this is not permitted. You may try to bid 26%, but then you get push-back from the dealer. They need their markup! And when you go to sell, you will have to take their markdown. This is characteristic of an inefficient marketplace.

Perhaps negatively affecting the Bond-to-Person (B2P) bond marketplace, state regulations in many states limit tax exemptions on coupons. Moreover, the B2P market suffers from, in general, a lack of sophisticated matching engines to enable bond sellers and investors fluid access to the secondary bond markets.

What is known is that (a) over the past 25 years, the bond market has been, on average, 79% larger than the stock market, (b) many of the investors rely primarily on income specialists for their personal purchase requests, (c) because most bonds do not trade on exchanges, investors have less access to information about prices, (d) bond market participants have become increasingly concerned about deteriorating liquidity, (e) a record high amount of debt outstanding has many wondering if there is a bubble in the bond market, (f) as the Fed raises interest rates, many are worried that bond investors will stampede to the exits, which would drive down bond prices across the wider economy.

What is needed is new and improved systems for marketing and purchasing bonds.

### SUMMARY

An embodiment described herein is a system to finance a bond buyer transaction request associated with a bond website comprising a computer associated with a financial institution (defining a financial institution computer), the financial institution computer having a memory, being associated with the electronic communications network, and being positioned to receive and process transaction request information from a second computer associated with an electronic forum for transactions (defining a bond website computer). The bond-to-person website computer is in communication with a third computer associated with an individual bond buyer (defining a bond-buyer computer). The bond-buyer computer is positioned to provide information for a bond-to-person transaction request through an electronic communications network. The bond-holder computer is positioned to communicate to the bond-to-person website computer a transaction offer responsive to the bond-to-person transaction request.

Another embodiment is a computer program product associated with a financial institution computer, stored on a tangible computer memory media, operable on a computer, and used to finance an individual bond transaction request associated with a bond-to-person website. The computer program product comprises a set of instructions that, when executed by the computer, cause the computer to perform the operations of receiving information about a bond-to-person transaction request associated with an electronic forum for bond-to-person transactions from the bond-to-person website computer, the transaction request from a bond buyer and having a preselected transaction value, determining whether to authorize a financial institutional transaction from a financial institution to the individual bond buyer requesting the transaction responsive to information in the bond-to-person transaction request, and offering to the individual bond buyer requesting the transaction the financial institutional transaction. The transaction offer has transaction terms determined by the financial institution responsive to the information in the bond-to-person transaction request. The computer also performs the operation of issuing the financial institutional transaction to the individual bond buyer making the bond-to-person transaction request responsive to approval by the individual bond buyer of the terms from the financial institution so that the bond-to-person transaction request is converted into proceeds from a financial institution transaction.

In embodiments, the operation of offering to the bond buyer requesting the transaction the financial institutional transaction can include offering a transaction having a preselected transaction value to the bond buyer prior to the transaction request being posted on the bond-to-person website, so that the bond buyer requesting the transaction can choose an immediate transaction offer with terms determined by the financial institution, or can choose to solicit bond buyer transaction offers with more favorable terms through the bond-to-person website.

In embodiments, the operation of offering to the bond buyer requesting the financial institutional transaction can also include identifying a deficiency amount for the bond-to-person transaction request associated with the bond-to-person website, the deficiency amount being the difference between the preselected transaction value of the bond-to-person transaction request and a value of an aggregate of any bond buyer transaction offers responsive to the bond-to-person transaction request and associated with the bond-to-person website, (the value of the aggregate being less than the preselected transaction value); and offering to the bond buyer requesting the transaction a gap filling fractional bond from a financial institution for the deficiency amount from a financial institution. The transaction offer can have transaction terms determined by the financial institution responsive to the information in the bond-to-person transaction request so that the transaction request can be partially satisfied by bond-buyer transaction offers.

In embodiments, the computer program product can further comprise a set of instructions that, when executed by the computer, cause the computer to perform the operations of: determining whether to authorize one or more fractional bond products from the financial institution to a bond buyer associated with the bond-to-person transaction request; offering for purchase one or more fractional bond products to the bond buyers associated with the bond-to-person transaction request. The fractional bond products include one or more of the following: transaction cancellation fractional bond products, and credit for fractional bond products. Furthermore, the computer performs the operation of issuing the one or more fractional bond products responsive to one or more purchases by the bond buyers associated with the bond-to-person transaction request and responsive to a closing of the transaction.

In embodiments, the computer program product further comprises a set of instructions that, when executed by the computer, cause the computer to perform the operations of: determining whether to authorize one or more insurance products from the financial institution to investor associated with the transaction request; offering for purchase one or more insurance products to the bond buyers associated with the transaction request, the insurance products including one or more of the following: transaction cancellation fractional bond products, and credit for bond default; and issuing the one or more insurance products responsive to one or more purchases by the investor associated with the transaction request and responsive to a closing of the transaction.

In embodiments, the bond-to-person bond website can solicit bond-to-person transaction requests having a maximum interest rate and responsively solicits transaction offers having an interest rate, the transaction offer interest rate being less than or equal to the transaction request maximum interest rate so that bond buyers can compete to fulfill the bond-to-person transaction request; wherein determining whether to authorize a financial institutional transaction from a financial institution to the bond buyer requesting the transaction responsive to information in the bond-to-person transaction request includes one or more preselected authorization parameters being related to a transaction underwriting model.

Another embodiment described herein is a computer program product associated with a financial institution computer, stored on a tangible computer memory media, operable on a computer, and used to finance a bond buyer transaction request associated with an electronic forum for bond-to-person transactions. The computer program product comprises a set of instructions that, when executed by the computer, causes the computer to perform the operations of: receiving information about a bond-to-person transaction request associated with an electronic forum for bond-to-person transactions, the transaction request from a bond buyer having a preselected transaction value, and the electronic forum defining a bond-to-person bond web-site; determining whether to authorize a financial institutional transaction from a financial institution to the bond buyer requesting the transaction responsive to information in the bond-to-person transaction request; offering to the bond buyer requesting the transaction, the financial institutional transaction, the transaction offer having transaction terms determined by the financial institution responsive to the information in the bond-to-person transaction request; and issuing the financial institutional transaction to the bond buyer making the bond-to-person transaction request responsive to approval by the bond buyer of the terms from the financial institution so that the bond-to-person transaction request is converted into proceeds from a financial institution transaction.

In embodiments, the operation of offering to the bond buyer requesting the transaction the financial institutional transaction includes offering a transaction having the preselected transaction value to the consumer prior to the transaction request being posted on the bond-to-person bond website so that the bond buyer requesting the transaction can choose an immediate transaction offer with terms determined by the financial institution or choose to solicit bond buyer transaction offers with more favorable terms through the bond-to-person bond website.

In embodiments, the operation of issuing the financial institutional transaction to the bond buyer making the bond-to-person transaction request can include loading the transaction value to a prepaid card to thereby convert the transaction request liquid portion of the account into a prepaid card having an associated value and being capable of purchasing goods.

In embodiments, the bond-to-person website can solicit bond-to-person transaction requests having a maximum interest rate and responsively solicit transaction offers having an interest rate; the transaction offer interest rate being greater than or equal to the transaction request minimum interest rate so that bond buyers can compete to fulfill the bond-to-person transaction request; wherein determining whether to authorize a financial institutional transaction from a financial institution to the bond buyer requesting the transaction responsive to information in the bond-to-person transaction request includes one or more preselected authorization parameters is related to a transaction underwriting model.

Another embodiment described herein is a computer-implemented method of satisfying a bond-to-person transaction request comprising: receiving information about a bond-to-person transaction request from an electronic forum for bond-to-person transactions by a computer associated with a financial institution (defining a financial institution computer) the transaction request from a bond buyer and having a preselected transaction value. The electronic forum defines a bond-to-person bond website. The method also includes determining by the financial institution computer whether to authorize a financial institutional transaction from a financial institution to the bond buyer requesting the transaction, responsive to information in the bond-to-person transaction request, and offering to the bond buyer requesting the transaction the financial institutional transaction by the financial institution computer, the transaction offer having transaction terms determined by the financial institution, responsive to the information in the bond-to-person transaction request.

The method further includes issuing the financial institutional transaction to the bond buyer making the bond-to-person transaction request responsive to approval by the bond buyer of the terms from the financial institution so that the bond-to-person transaction request is converted into proceeds from a financial institution transaction.

In embodiments, the method further comprises determining whether to authorize one or more fractional bond products, offering for purchase one or more fractional bond products to the bond buyers associated with the bond-to-person transaction request, the fractional bond products including credit life fractional bond products; and issuing the one or more fractional bond products responsive to one or more purchases by the bond buyers associated with the bond-to-person transaction request and responsive to a closing of the transaction.

An embodiment described herein is a system to facilitate investor requests for Notes that are backed by bonds associated with a bond website comprising: a computer associated with a financial institution (defining a financial institution computer), the financial institution computer having memory, the financial institutional computer being associated with an electronic communications network and configured to receive and process transaction request information from a second computer associated with an electronic forum for transactions (defining a bond-to-person website computer) wherein the bond-to-person website computer is in communication with a third computer associated with an individual investor (defining an investor computer) and further in communication with one or more fourth computers associated with Note-holders (defining a Note-holder computer). The investor computer is configured to provide information for a transaction request through the electronic communications network, and the Note-holder computer is configured to communicate with the bond-to-person website computer to transfer an offer responsive to the investor transaction request.

Another embodiment described herein is a computer program product associated with a financial institution computer. The computer program product is stored on a tangible computer memory media and is configured to finance an investor transaction request associated with a bond-to-person website. The computer program product comprises a set of instructions that, when executed by the computer, cause the computer to perform the operations of: receiving information about an investor request associated with an electronic forum for transactions from the bond-to-person website computer, (the transaction request from an investor having a preselected transaction value), determining whether to authorize a financial institutional transaction from a financial institution to the individual investor requesting the transaction responsive to information in the transaction request, offering to the investor requesting the transaction, the financial institutional transaction, (the transaction offer having transaction terms determined by the financial institution responsive to the information in the investor transaction request), and issuing the financial institutional transaction to the investor, making the investor transaction request responsive to approval by the investor of the terms from the financial institution so that the investor transaction request is converted into proceeds from a financial institution transaction.

Another embodiment described herein is a computer program product associated with a financial institution computer, stored on a tangible computer memory media, operable on a computer, and used to finance an investor transaction request associated with an electronic forum for transactions. The computer program product comprises a set of instructions that, when executed by the computer, cause the computer to perform the operations of: receiving information about a transaction request associated with an electronic forum for transactions, (the transaction request from an investor and having a preselected transaction value), the electronic forum defining a bond-to-person web-site. The embodiment further comprises determining whether to authorize a financial institutional transaction from a financial institution to the investor requesting the transaction responsive to information in the transaction request; offering to the investor requesting the transaction the financial institutional transaction, (the transaction offer having transaction terms determined by the financial institution responsive to the information in the transaction request); and issuing the financial institutional transaction to the investor, making the transaction request responsive to approval by the investor of the terms from the financial institution so that the transaction request is converted into proceeds from a financial institution transaction.

Another embodiment described herein is a method of satisfying a transaction request with a preselected transaction value comprising: receiving information about a transaction request from an electronic forum for transactions by a computer associated with a financial institution (defining a financial institution computer), the transaction request from an investor and having a preselected transaction value, the electronic forum defining a bond-to-person website. The method further comprises determining by the financial institution computer whether to authorize a financial institutional transaction from a financial institution to the bond-buyer requesting the transaction responsive to information in the transaction request; offering to the investor requesting the transaction the financial institutional transaction by the financial institution computer, the transaction offer having transaction terms determined by the financial institution responsive to the information in the transaction request; and issuing the financial institutional transaction to the investor making the transaction request responsive to approval by the investor of the terms from the financial institution so that the transaction request is converted into proceeds from a financial institution transaction.

In embodiments, the method further comprises a reader reading data on the prepaid card to access the transaction value on the prepaid card to represent a visual depiction of the transaction value on a display associated with the reader and to complete a transaction of goods to thereby convert the data on the prepaid card into goods.

An embodiment described herein is a method comprising obtaining investor specific transaction information for a first investor and a second investor from an electronic forum for requesting an investment transaction involving a structured financial note and comparing, by a processor, the obtained investor specific transaction information with pre-determined financial institution acceptance criteria to determine whether to authorize transactions with the first investor and the second investor. The step of comparing includes reading, by an automated program, the investor specific transaction information and sorting the information into transaction request information and investor qualifications information, identifying a deficiency amount from the transaction request information for the first and second investors, analyzing the investor qualifications information to determine if the investor's qualifications meet or exceed the pre-determined financial institution acceptance criteria, and determining whether to authorize sale of a first fraction of the structured financial note to the first investor, and a second fraction of the structured financial note to the second investor, at pre-selected terms from the financial institution when the analysis of the first investor qualifications information and the second investor qualifications information meets or exceeds the pre-determined financial institution acceptance criteria.

In embodiments, the method further comprises transmitting to the first and second investors offers for transactions having preselected transaction values prior to transaction data being posted on the electronic forum so that the first and second investors can opt to select an immediate transaction offer with terms determined by a financial institution.

In embodiments, the method further comprises issuing a first fraction of the structured financial note to the first investor, and a second fraction of the structured financial note to the second investor.

In embodiments, the structured financial note comprises at least one member selected from the group consisting of fractional credit products, fractional insurance products and fractional bond products.

Another embodiment described herein is a method comprising receiving at least first and second fractional structured financial note purchase requests from first and second remote purchase request computer terminals and displaying them on a website, receiving an approved deficiency amount from a structured financial note broker from a broker remote computer terminal for a structured financial note sale and displaying it on a website, determining whether to complete a structured financial note transaction based upon whether an aggregate of structured financial note purchase requests meets the terms of sale based on data received from the broker remote computing terminal, transmitting final terms of the structured financial note transaction to the broker remote computer terminal, and transmitting final terms of fractional portions of the structured financial note transaction to the first and second remote purchase request computer terminals.

In embodiments, the method further comprises facilitating the purchase of fractional structured financial notes by sending information to, and receiving information from the first and second remote purchase request computer terminals and the broker remote computer terminal.

In embodiments, the method further comprises sending information to and receiving information from a financial institution computer, wherein the financial institution guarantees the fractional structured financial note sale.

In embodiments, the method further comprises the financial institution delegating authorization of the purchase of fractional structured financial notes to a service provider.

Another embodiment is a method comprising receiving a fractional structured financial note sale offer from a structured financial note broker remote computer terminal, displaying a fractional structured financial note sale offer on a website, receiving information from at least first and second buyers through first and second remote computer terminals indicating that the buyers accept fractional structured financial note sale offers, determining whether to complete a structured financial note transaction based upon whether an aggregate of buyers that accept the terms of the sale offer is sufficient according to the terms of the sale offer based upon data received from the broker remote computing terminal, transmitting final terms of the structured financial note transaction to the structured financial note broker remote computer terminal, and transmitting final terms of the fractional structured financial note sale to the first and second remote computer terminals.

In embodiments, the method further comprises executing the fractional structured financial note sale immediately after transmitting the final terms of sale.

In embodiments, the method further comprises facilitating the closing of a transaction between the structured financial note broker and buyers.

In embodiments, the terms of the fractional structured financial note sale first offer are pre-negotiated with the structured financial note broker by a first service provider.

In embodiments, the terms of the immediate fractional structured financial note sale offer are determined by the structured financial note broker.

In embodiments, the method further comprises sending information to and receiving information from a financial institution computer, wherein the financial institution guarantees the fractional structured financial note sale.

In embodiments, the financial institution delegates authorization of the purchase of fractional structured financial notes to a second service provider.

Another embodiment is a system for selling fractional structured financial notes to buyers comprising a central computer configured to receive data indicative of at least one fractional structured financial note purchase request from at least first and second buyer remote computing terminals, receive data indicative of a transaction deficiency amount from a broker remote computing terminal, determine whether the aggregate of purchase requests received fulfills the terms of a transaction deficiency amount, transmit data indicative of transaction details to the first and second buyer remote computing terminals and the broker remote computing terminal, and facilitate data transfer between the first and second buyer computing terminals and the central computer, and the structured financial note holder computer terminal and the central computer.

In embodiments, the system further comprises executing a sale of fractional structured financial notes immediately after transmitting the final terms of the sale.

Another embodiment described herein is a computer program product for selling fractions of a structured financial note to buyers comprising one or more computer readable storage media, and program instructions stored on the one or more computer readable storage media. The program instructions comprise: program instructions to receive investor data from a plurality of investors, wherein the investor data includes investor specific transaction information, program instructions to receive financial institution data from a financial institution for the structured financial note to be sold to at least a portion of the plurality of investors, responsive to receiving investor data and financial institution data, program instructions to determine an investor group using an algorithm which determines: which of the plurality of investors meet the investor qualifications for the transaction, and the fractional amount of the structured financial note to be sold to each investor, and program instructions to transmit transaction data to investors. In embodiments, the computer program product further comprises program instructions to receive payments from investors and transmit data to investors indicative of fractional ownership of the structured financial note.

Some of the objects and advantages of the disclosed embodiments will now be set forth. While other objects and advantages may be obvious from the description, others may be learned through practice.

### BRIEF DESCRIPTION OF THE DRAWINGS

A full and enabling description of the present subject matter, directed to one of ordinary skill in the art, is set forth in the specification, which refers to the appended figures, in which:

FIG. 1 is a schematic flow diagram of a method of synthesizing a Note in response to a gap filling bond fraction request according to one exemplary embodiment.

FIG. 2 is a schematic flow diagram of a method of satisfying a Note request according to one exemplary embodiment.

FIG. 3A is a system to finance and satisfy an investor (a buyer of a Note backed by a bond or fraction thereof) request according to an embodiment.

FIG. 3B illustrates a simplified embodiment of data flow in a system in which the investor computer initiates data flow in a Note selling process.

FIG. 3C illustrates a simplified embodiment of data flow in a system in which the financial institution computer initiates data flow in a Note selling process.

FIG. 3D illustrates a detailed embodiment of data flow in a system in which the bond-buyer computer initiates the data flow

FIG. 3E illustrates a detailed embodiment of data flow in a system in which the financial institution computer initiates the data flow for the proposed transaction.

FIG. 4 is a partial schematic diagram of a computer program product for creating a Note that is backed by some fraction of a bond, called a “fractional bond” in response to a bond request according to an embodiment.

FIG. 5 is a partial schematic diagram of a computer program product for satisfying a Note request according to another embodiment.

FIG. 6 is a flowchart of a process of issuing a gap-filling Note from a financial institution according to an embodiment.

FIG. 7 is a flowchart of a process of issuing a loan from a financial institution responsive to a loan request according to an embodiment.

FIGS. 8A and 8B are respective front and rear views of a prepaid card according to embodiments.

FIG. 9 is a schematic block diagram of a point-of-sale hardware device according to an embodiment.

FIG. 10 is a schematic flow diagram of a method of synthesizing gap-filling bond fractions in response to a gap filling bond fraction request according to one exemplary embodiment.

FIG. 11 is a schematic flow diagram of a method of satisfying a bond request according to one exemplary embodiment.

FIG. 12 is a system to finance and satisfy a bond-buyer (a buyer of a bond represented by a bond or fraction of a bond) request according to an embodiment.

FIG. 13 is a partial schematic diagram of a computer program product for creating a bond fraction that is backed by some fraction of a bond, called a “fractional bond” in response to a bond request according to an embodiment.

FIG. 14 is a partial schematic diagram of a computer program product of satisfying a bond fraction request according to another embodiment.

FIG. 15 is a flowchart of a process of issuing a gap-filling fractional bond from a financial institution according to an embodiment.

FIG. 16 is a flowchart of a process of issuing a loan from a financial institution responsive to a loan request according to an embodiment.

Repeated use of reference characters throughout the present specification and appended drawings is intended to represent the same or analogous features or elements of the present technology.

### DETAILED DESCRIPTION

The present disclosure relates generally to a new and improved system for the financial service and bond industries.

Reference now will be made in detail to the embodiments, one or more examples of which are set forth below. Each example is provided by way of detailed descriptions of multiple embodiments not in limitation of what is claimed. In fact, it will be apparent to those skilled in the art that various modifications and variations can be made to the system without departing from the scope or spirit of the claims. For instance, features illustrated or described as part of one embodiment can be used on another embodiment to yield a still further embodiment. Thus, it is intended that the present disclosure covers such modifications and variations as come within the scope of the appended claims and their equivalents. Other objects, features, and aspects of the present disclosure are disclosed in or may be determined from the following detailed description. Repeated use of reference characters is intended to represent same or analogous features, elements or steps. It is to be understood, by one of ordinary skill in the art, that the present discussion is a description of exemplary embodiments only, and is not intended as limiting the broader aspects of the present claims.

For the purposes of this document two or more items are “mechanically associated” by bringing them together or into relationship with each other in any number of ways including a direct or indirect physical “releasable connections” (snaps, screws, Velcro®, bolts, etc.—generally connections designed to be easily and frequently released and reconnected), “hard-connections” (welds, rivets, macular bonds, generally connections that one does not anticipate disconnecting very often if at all and that is “broken” to separate), and/or “moveable connections” (rotating, pivoting, oscillating, etc.).

Similarly, for the purposes of this document, two items are “electrically associated” by bringing them together or into relationship with each other in any number of ways. For example, methods of electrically associating two electronic items/components include: (a) a direct, indirect or inductive communication connection, and (b) a direct/indirect or inductive power connection. Additionally, while the drawings illustrate various components of the system connected by a single line, it will be appreciated that such lines represent one or more connections or cables as required for the embodiment of interest.

For the purposes of this document, unless otherwise stated, the phrase “at least one of A, B, and C” means there is at least one of A, or at least one of B, or at least one of C or any combination thereof (not one of A, and one of B, and one of C).

This document includes headers that are used for place markers only. Such headers are not meant to affect the construction of this document, do not in any way relate to the meaning of this document nor should such headers be used for such purposes.

As used herein, “investor specific transaction information” is defined as a combination of investor information and transaction information. It can include who is transacting what and when the transaction occurs. It can also include the status of the investor (e.g. an accredited investor).

As used herein, an “accredited investor” is a person or entity that can deal with securities not registered with financial authorities by satisfying one of the requirements regarding income, net worth, asset size, governance status or professional experience. An “investment transaction” is defined herein as a buy or sell order of a structured financial note that includes, but is not limited to, the market value, notional amount, the date and the time.

As used herein, “pre-determined financial institution acceptance criteria” is defined as the minimal requirement for a transaction to occur. For example, the investment may require $10 million, but was only able to raise $9 million. As a result, the offer is canceled and funds are returned to investors. “Transaction request information” is defined as including, but is not limited to, the amount committed to the investment and investor specific transaction information.

As used herein, “investor qualifications information” is defined as including funding status, accredited investor status, registered advisor or investment advisor status. “Pre-determined financial institution acceptance criteria” is defined as including the manner to establish investor qualifications information. For example, an outside vendor can be relied upon to check on the status.

As used herein, “fractional bond represented by a note” means a legal document representing a fractional ownership interest in a bond. A “structured financial note” refers to a security that may be exempted from SEC registration by its regulation D status. In embodiments, this may include a series LLC that is backed by an asset. The note may contain elements that pertain to restrictions on resale, the assets that are backed, payout provisions and ownership limitations. For example, Rule 144 allows for resale, but only after a 1 year waiting period and then only to accredited investors. In the preferred embodiment, the note is only part of a larger debt. The note may be subjected to many “pre-selected terms”.

As used herein, “pre-selected terms” include one or more of cash-on-cash return, internal rate of return, After Repair Value (for real-estate), and time before cash out. As used herein, a “first service provider” and a “second service provider” can be the same service provider.

In view of the foregoing, the Applicant has recognized one or more sources of many of these problems and provides enhanced embodiments of computerized methods of facilitating investor transaction requests associated with B2P transactions, associated systems, and computer program products.

What is needed is the “Note”. The Note is a new apparatus and method (backed by bonds, fractions of bonds and optional insurance) that enables investors to purchase fractions of different bonds with varying quality.

According to embodiments, when an investor associated with a Note-purchase website, or other communication network, does not get a Note-purchase request fully funded for the preselected Note value, the financial institution can solicit Note sales from Note holders. The financial institution identifies the deficiency amount for a Note-purchase request, determines whether to authorize a transaction for the deficiency amount, authorizes a Note backed by a bond (or fraction thereof) at preselected terms, and facilitates the transaction. As understood by those skilled in the art, the financial institution serves as a Note broker for Note-purchase requests and can subdivide bonds (or bond tranches) to fulfill an uncommitted portion of the Note requests.

As understood by those skilled in the art, the financial institution sets up a bond investment conduit (BIC), which is used for the pooling and securitization of investments into a bond tranche. Some benefits include, for example, a significant increase in Note-purchase closings. In addition, investors now have an option of a blended risk and coupon rates, according to embodiments. Investors can now place good-to-cancel, or fixed time-limited limit orders that split the bid and ask price. Investors can offer Notes to each other, improving volume, liquidity, price and efficiency.

For example, if a consumer posts a request for $4,000 with a 10% maximum coupon limitation, but only a bond for $2,000 at 10% is available, the consumer is out of luck, using prior art apparatus and methods. However, using the disclosed Note apparatus and method, a financial institution can offer a Note backed by a fractional bond of $2,000 at the 10% interest rate along with an offer to sell the remaining $2,000, the deficiency amount, at a rate of 5%. The consumer can then choose to accept a blended rate of 7.5% (being $2,000 at 10% and $2,000 at 5%), (which includes a $2,000 bond at the desired 10% rate), or no bond at all. Moreover, the involvement of the financial institution, for example, can advantageously put competitive or timing pressures on investors to thereby force greater competition and add an increased time component to the transactions.

According to other embodiments, a financial institution can provide immediate Note offers responsive to an investor request of preselected Note parameters associated with the B2P web-site so that the investor can choose the immediate offer, with terms determined by the financial institution, or choose to solicit investor offers with more favorable terms through the website. As understood by those skilled in the art, the immediate Note sale option provided by the financial institution, can guarantee that the Note will be supplied (assuming the Note-holder is willing to accept the terms of the financial institution) and establishes a ceiling on the “zone of possible agreement.” For example, if an investor posts a request for a $5,000 Note with a range of between 8% and 10%, the financial institution can make an immediate offer for a Note at a rate of 8%. The investor can then choose to accept the rate of 8% immediately, if timing is critical, or choose to wait for offers with a more favorable rate, if timing is less critical. As understood by those skilled in the art, the benefits of immediate offerings include an increase in transaction closings and an increase in the availability of a blended rate for the investor. The blended rate may or may not exceed the desired rate or a maximum rate of the B2P transaction request.

Using “limit” orders that split the bid and ask prices, with a specified time limit, customers can establish their willingness to purchase or sell notes at any given price (something not permitted by current bond brokers). This enables improved liquidity, increased transaction volume and reduces the spread between the bid and ask prices, thus improving market efficiency.

According to yet other embodiments, a financial institution can guarantee a B2P transaction associated with a B2P website. The B2P website receives the transaction request. Then, the financial institution determines whether to authorize products associated with the B2P transaction request; offers for purchase of one or more products, including, for example offers to buy or sell Notes with mark-ups or mark-downs, in accordance with the demand of the market.

As understood by those skilled in the art, the disclosed methods and apparatuses are significantly more than just an approved bond marketing system or a system for entering binding contracts but a system and method for providing the availability of Notes that reduce investor risk, improve the comfort level of an investor with respect to repayment, and provide assurances to an investor resulting in a greater willingness to enter transactions. Therefore, embodiments of the present disclosure result in a significant increase in transaction closings. As an example, an investor is “on the fence” on a transaction request, because of the size and risk of the underlying bond, then the investor can enter a bid for a fraction of the bond tranche for a limited time, on the B2P web site. Because the Note is a pass-through representation of the bond, a bond failure will trigger a Note failure. During Note portfolio synthesis, with sufficient diversification, the expected return should be the average of the expected weighted return on the notes held in the investor's portfolio.

For example, suppose the investor would like to learn what will happen to the portfolio if a given investment is made. The B2P website provides a tool that can compute the proposed new duration (weighted average of the maturities of the cash flows). Weights for each cash flow are computed as the present value of the cash flow divided by the total present value of all cash flows. The metrics (duration, yield to maturity, etc.), can help the investor to manage their own portfolios. Other what-if tools in the B2P website can project what would happen if one or several creditors (companies or countries) default in a portfolio of high-yield bonds.

According to another embodiment, the financial institution can be a federally chartered broker subject to federal security laws and regulations and preferably not subject to state security laws and regulations. Therefore, the federally-chartered financial institution enjoys rate preemption; that is, state licensing requirements, as well as regulations, in many states, are preempted and do not apply to the federally-chartered financial institution. As understood by those skilled in the art, a federally chartered financial institution can operate in every state with a consistent implementation nationally rather than a state-by-state approach and can charge a transaction fee for Notes and/or insurance and/or financing without regard to state law.

Embodiments can also include additional features. For example, the financial institution can bundle the gap-filling transactions, immediate financing transactions, or both for sale on secondary capital markets, as understood by those skilled in the art.

According to embodiments, the financial institution can employ sophisticated underwriting models and preselected authorization parameters to determine whether to authorize a gap-filling transaction or a transaction for the entire selected value, or for one or more fractional bond products.

Embodiments can provide other benefits to the B2P bond website. An association with the financial institution, for example, can legitimize the B2P website. The addition of gap filling transactions, according to embodiments, allows the B2P website to preserve its social feel with the financial institution serving as a backstop for Note-holders. Also, reporting the financial institution performance, as understood by those skilled in the arts, can create a “Beat the Stuffy, White Shirt Bond Broker” promotional opportunity for the B2P web site.

For a financial institution, for example, embodiments provide additional benefits not provided by prior art systems/methods, including a lower cost customer acquisition channel and cross-marketing opportunities for other products and services. As understood by those skilled in the art, the financial institution can purchase Notes from investors, forming a secondary market and providing investors the ability to access cash tied up in Notes. Additionally, the financial institution can share its sophisticated models and preselected authorization parameters with investors wanting to piggyback on the financial institution's credit standards, according to embodiments, to thereby further legitimize the B2P web-site and the underwriting and performance data reported by the B2P web-site, as understood by those skilled in the art.

Embodiments provide a system to finance investor transaction requests associated with a B2P web-site. The system can include a first computer defining a consumer computer, which includes a program product, e.g., software, stored in memory to provide information for a B2P transaction request through an electronic communications network, e.g., the Internet or World Wide Web, to a second computer defining a B2P web-site computer. The B2P web-site computer has an electronic forum for hosting a B2P transaction request and for transaction offers by one or more investors. The transaction request information includes a preselected transaction value. Each transaction offer associated with the electronic forum is responsive to the B2P transaction request and has a transaction value that fulfills all or a portion of the preselected transaction value. The system further includes one or more third computers defining a Note-holder (investor) computer, which can include, for example, a program product stored in memory to provide transaction offer information responsive to the B2P transaction request to the B2P web-site computer through the electronic communications network. The system also, for example, can include a fourth computer defining a financial institution computer, which receives transaction information from the B2P web-site computer through the electronic communications network. The financial institution computer can include a program product, for example, as discussed below.

Embodiments include, for example, a program associated with a financial institution computer, stored on a tangible computer memory media, operable on a computer, and used to finance investor's transaction request. The computer program product, for example, can include a set of instructions that, when executed by the computer, cause the computer to perform various operations. The operations include identifying a deficiency amount for the B2P transaction request associated with the B2P bond website. The deficiency amount is the difference between the pre-selected transaction value of the B2P transaction request and a value of an aggregate of investor transaction offers responsive to the B2P transaction request, if the value of the aggregate is less than the preselected transaction value. The operations also include the financial institution determining whether to authorize a gap-filling transaction for the deficiency amount to an investor requesting the transaction and authorizing the gap-filling transaction for the deficiency amount at preselected transaction terms. The operations further include issuing the gap-filling transaction to the investor making the B2P transaction request responsive to approval of the preselected terms by the investor.

In addition, embodiments include other program products, systems, and associated methods for satisfying a B2P transaction request, as will be understood by those skilled in the art.

Additional objects and advantages are set forth in the detailed description herein or will be apparent to those skilled in the art upon reviewing the detailed description. Also, it should be further appreciated that modifications and variations to the specifically illustrated, referenced, and discussed steps, or features hereof may be practiced in various uses and embodiments without departing from the spirit and scope of this disclosure, by the present reference thereto. Such variations may include, but are not limited to, substitution of equivalent steps, referenced or discussed, and the functional, operational, or positional reversal of various features, steps, parts, or the like. Still further, it is to be understood that different embodiments, as well as different presently preferred embodiments, may include various combinations or configurations of presently disclosed features or elements, or their equivalents (including combinations of features or parts or configurations thereof not expressly shown in the figures or stated in the detailed description).

Those of ordinary skill in the art will better appreciate the features and aspects of such embodiments, and others, upon review of the remainder of the specification.

The methods, systems, and embodiments relate to products, systems, and associated methods to finance a gap filling bond request with a fractional bond. In embodiments, the fractional bond is represented by a Note. The Note provides ownership of a fraction of a bond (or fraction of a tranche) as well as optional insurance. Insurance is available for (but not limited to) life insurance (e.g. death bonds) and default insurance.

While the particulars of the disclosed embodiments and associated technology may be described for use with purchasing Notes backed by bonds, the embodiments may be adapted for use with any type of investment products that are purchased and sold including real estate time sharing investments, crowd funding, crowd investing or crowd sourcing.

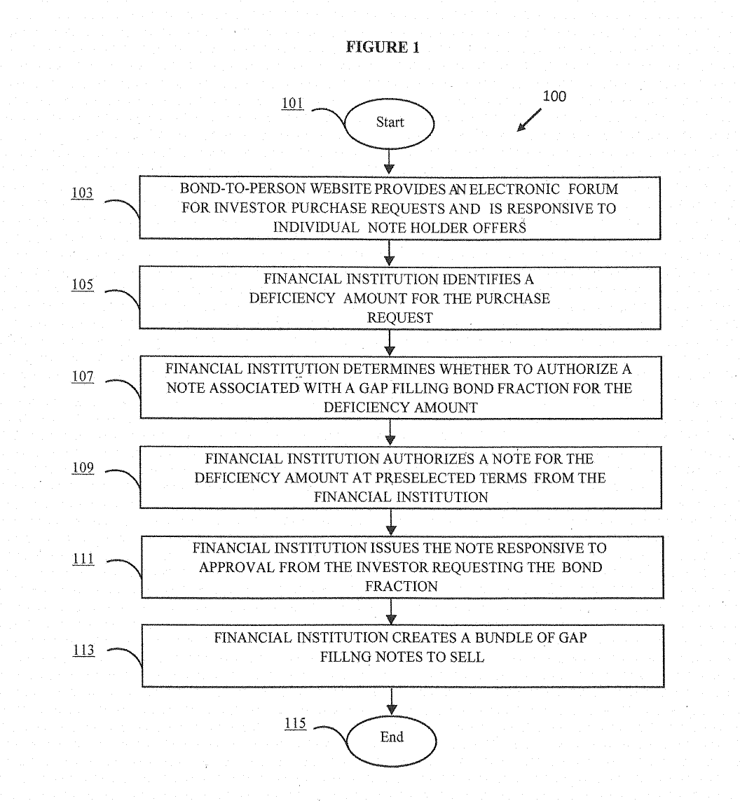

FIG. 1 depicts an overview of one exemplary embodiment. Such embodiments provide computerized methods of satisfying an investor transaction request associated with a B2P website, and associated systems and program products (block 103). Embodiments provide for financing a deficiency amount for a B2P transaction request, satisfying a B2P transaction request with a transaction from a financial institution, and guaranteeing a B2P transaction based on the purchase request (block 105).

The method 100 starting at block 101, for example, includes a B2P website providing an electronic forum for a B2P transaction request by an investor and for transaction offers by one or more investors (block 103). Ideally, each transaction offer is responsive to the B2P transaction request and has a transaction value that fulfills all or a portion of the preselected transaction value. When the full request is not fulfilled, the method also includes identifying a deficiency amount for the B2P transaction request associated with the B2P web-site (block 105). The deficiency amount is the difference between the preselected transaction value of the B2P transaction request and a value of an aggregate of any investor offers responsive to the B2P transaction request. If the value of the aggregate is less than the preselected transaction value, for example, the method further includes determining whether to authorize a gap filling transaction for the deficiency amount from a financial institution to the investor requesting the transaction (block 107). Next the financial institution authorizes the gap-filling fractional Note for the deficiency amount at preselected transaction terms from the financial institution (block 109). The method continues with issuing the gap filling Note to the investor making the B2P transaction request responsive to approval of the preselected terms by the investor (block 111). The method further includes the financial institution creating a collection of a plurality of B2P transactions to define a bundle of B2P transactions to sell, in which a bundle includes one or more gap filling transactions (block 113). The method ends at block 115.

As understood by those skilled in the art, the financial institution serves as stop-gap for investor requests that are not fully satisfied but meet the financial institution's strategy, fulfilling the uncommitted portion of the transaction requests. Benefits over prior art methods include, for example, a significant increase in transaction closings as otherwise unsatisfied transaction requests gain a second opportunity, more options for a blended rate for investors, and additional pressure on Note holders due to the financial institution involvement, as understood by those skilled in the art. Moreover, the sale of transactions, for example, gap filling transactions, in a collection, bundle, or pool can reduce risk through diversification and can make, for example, otherwise minor and uneconomical investments of sufficient worth for interest by secondary capital markets, as understood by those skilled in the art. Thus, the embodiments disclosed are supplements in addition to a B2P website.

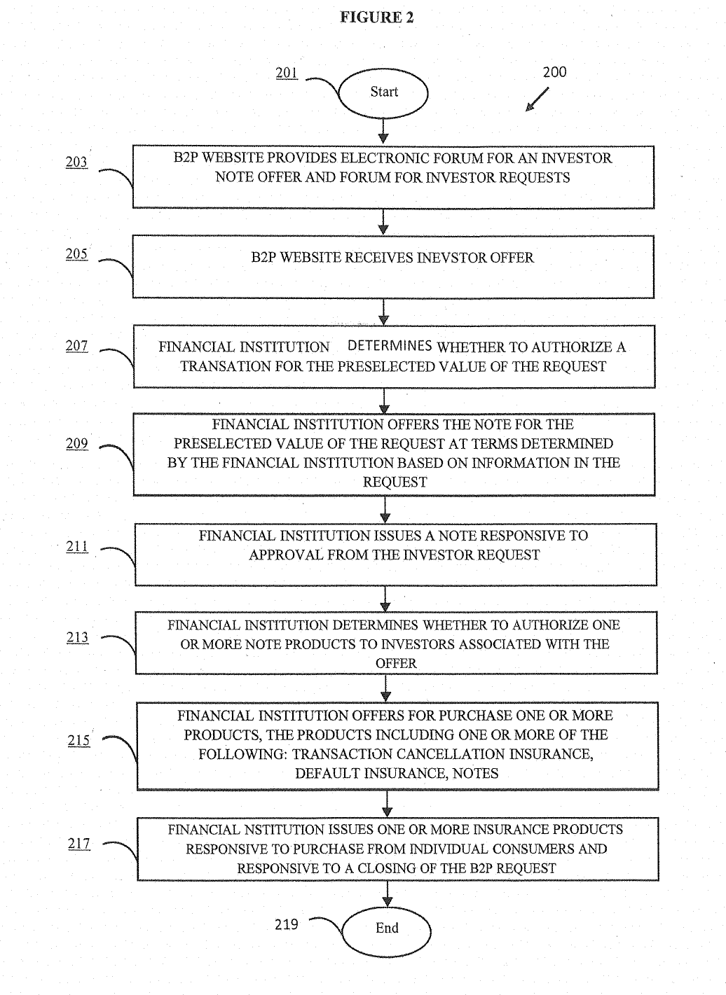

FIG. 2 illustrates another embodiment of a method 200 starting at block 201, which, for example, provides a computer-implemented method of satisfying a request. The computer-implemented method includes a B2P web-site providing an electronic forum for B2P transaction requests by an investor and for transaction offers by one or more investors' (block 203). The transaction request has a preselected transaction value. Each transaction offer made is responsive to the B2P transaction request and has a transaction value that fulfills all or a portion of the preselected transaction value (block 205). The transaction request includes information about the investor making the B2P transaction request, as understood by those skilled in the art. The computer-implemented method further includes a financial institution determining whether to authorize a financial institutional transaction for the pre-selected transaction value to the investor making the B2P transaction request based on the information in the B2P transaction request (block 207). The computer-implemented method continues with the financial institution offering the financial institutional transaction for the pre-selected transaction value at transaction terms determined by the financial institution based on information in the B2P transaction request. Such allows the investor requesting the transaction to choose a transaction offer with terms determined by the financial institution or choose to solicit investor transaction offers with more favorable terms through the B2P bond website (block 209). The computer-implemented method further includes issuing the financial institutional transaction responsive to approval by the investor requesting the transaction of the terms from the financial institution (block 211). In addition, the computer-implemented method includes the financial institution determining whether to authorize one or more Notes to the investor associated with the B2P transaction request (block 213). The computer-implemented method continues with the financial institution offering for purchase one or more insurance products to the Note buyers associated with the Note request (block 215). The product offerings include one or more of the following: default insurance, transaction cancellation insurance and Notes backed by some fraction of a bond, as understood by those skilled in the art. The computer-implemented method also includes issuing one or more insurance products responsive to a purchase from investors and responsive to a closing of the transaction (block 217). The method ends at block 219.

As understood by those skilled in the art, a financing option provided by the financial institution can enable transaction funding (assuming the consumer is willing to accept the terms of the financial institution) and establishes a ceiling on the “zone of possible agreement.” Other benefits of immediate financing embodiments, i.e., prior to a transaction auction, and gap filling transaction embodiments, i.e., after a transaction auction, especially in combination when the consumer is effectively pre-qualified for the gap filling transaction, include an increase in transaction closings and an increase in the availability of a blended rate for the consumer. A blended rate may or may not exceed the desired rate (yield) or a maximum rate of the B2P transaction request, as understood by those skilled in the art. The availability of fractional bond products can reduce investor risk, improve the comfort level of a Note-holder with respect to repayment, and provide assurance to an investor, resulting in a greater willingness to enter into transactions, as understood by those skilled in the art.

According to other embodiments, the financial institution can be a federally chartered broker subject to security laws and regulations and not subject to state laws and regulations. Therefore, the federally chartered financial institution enjoys rate preemption; that is, state licensing requirements are preempted and do not apply to the federally chartered financial institution. As understood by those skilled in the art, a federally chartered financial institution can operate in every state with a consistent implementation nationally rather than a state-by-state approach and can charge any rate for the gap filling transactions or immediate financing transactions without regard to state law.

Embodiments include additional features, as will be understood by those skilled in the art. The financial institution, for example, can employ various levels of sophisticated underwriting models and preselected authorization parameters to determine whether to authorize a gap filling transaction, a financial institutional transaction for the entire selected transaction value, and one or more products to guarantee the transaction, according to embodiments, so that transaction request data is converted into transaction offer data. Based on information from the credit reporting agencies that investors on the B2P site would not otherwise have access to or the sophistication to develop, such models, for example, may include a behavior a rating score that considers the consumer's credit score, length of employment, the presence of recent derogatory credit information such as bankruptcy, ability to provide direct deposits to the financial institution, or direct deposit history.

Embodiments provide other benefits to the B2P website. An association with the financial institution can legitimize the B2P website, as understood by those skilled in the arts. The addition of gap filling transactions, according to the embodiments, allows the B2P website to preserve its social feel with the financial institution serving simply as a backstop for both investors and Note-holders. Also, reporting the financial institution performance, as understood by those skilled in the art, for example, can create a “Beat the Stuffy, White Shirt Bond Broker” promotional opportunity for the B2P website.

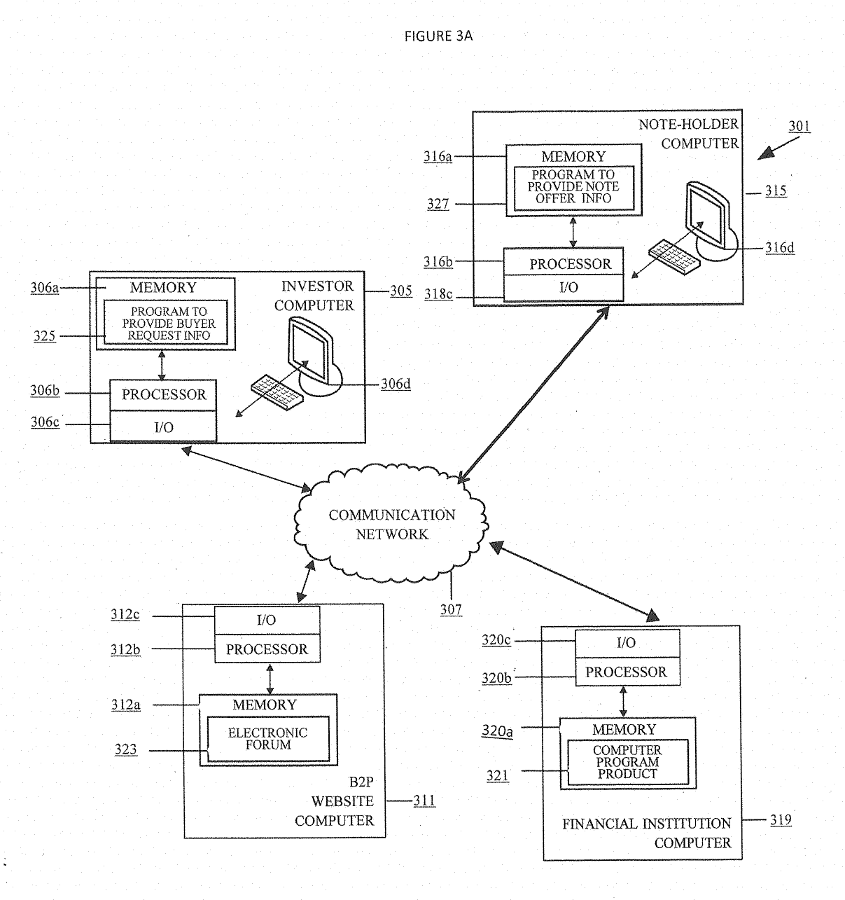

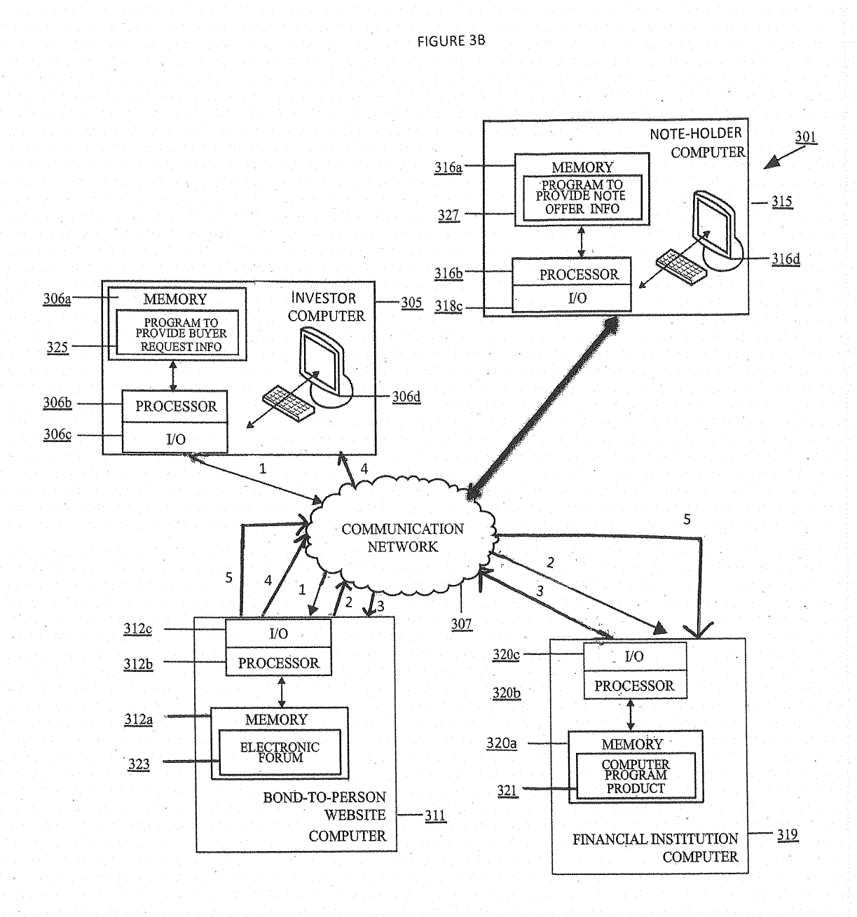

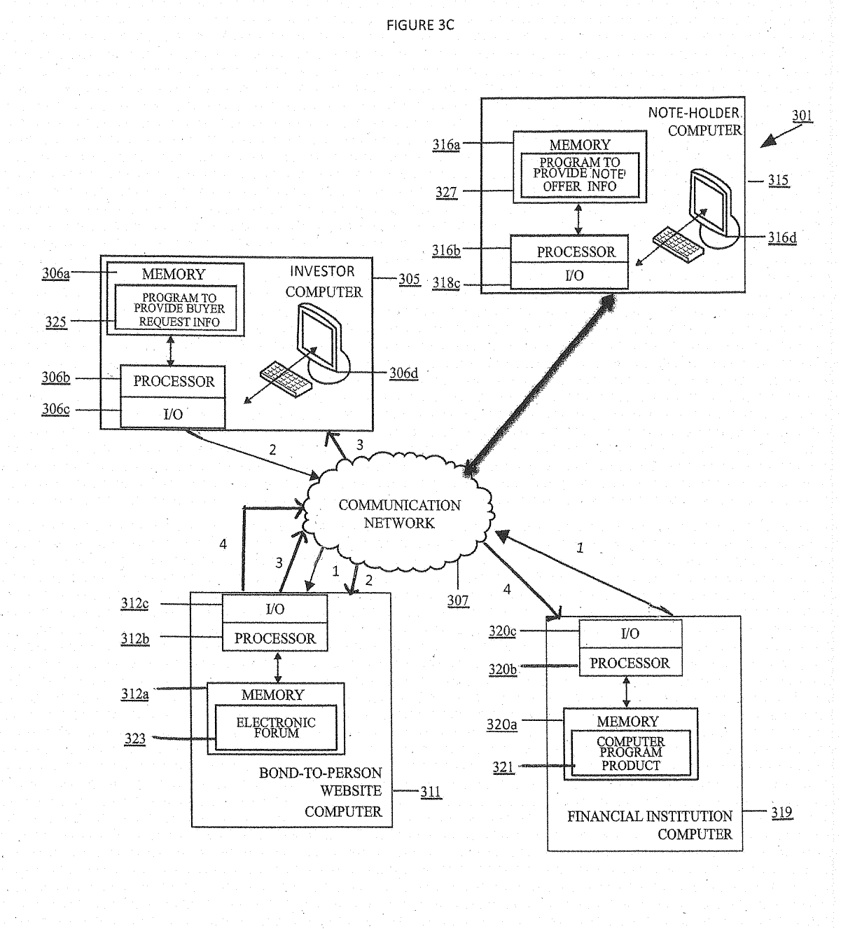

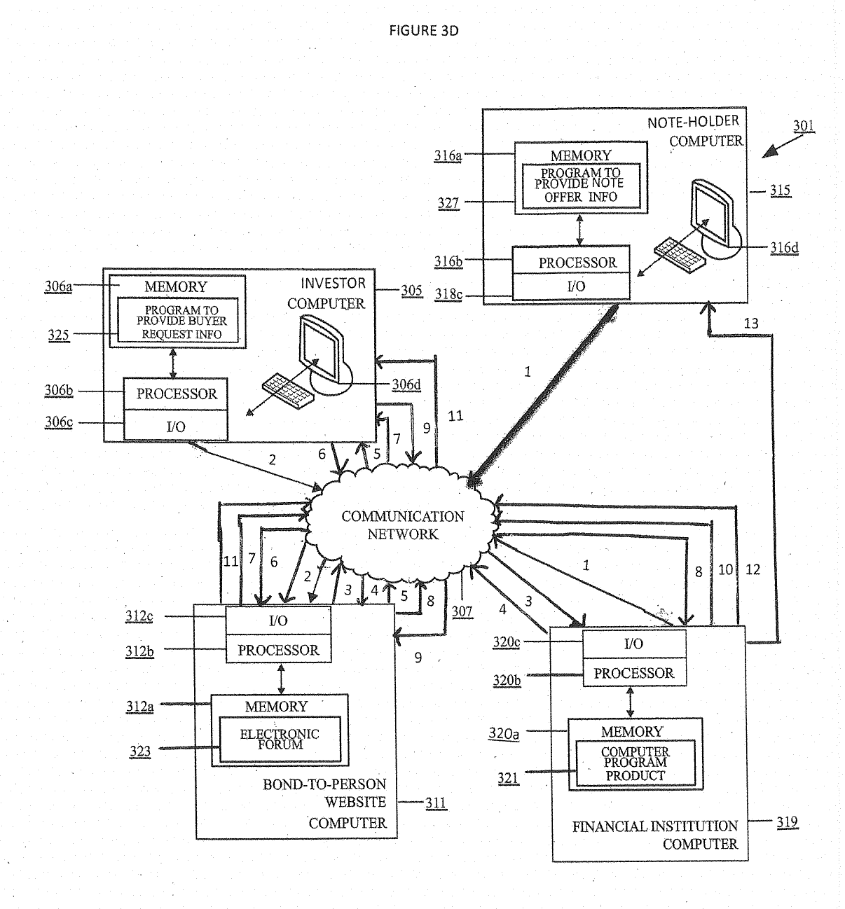

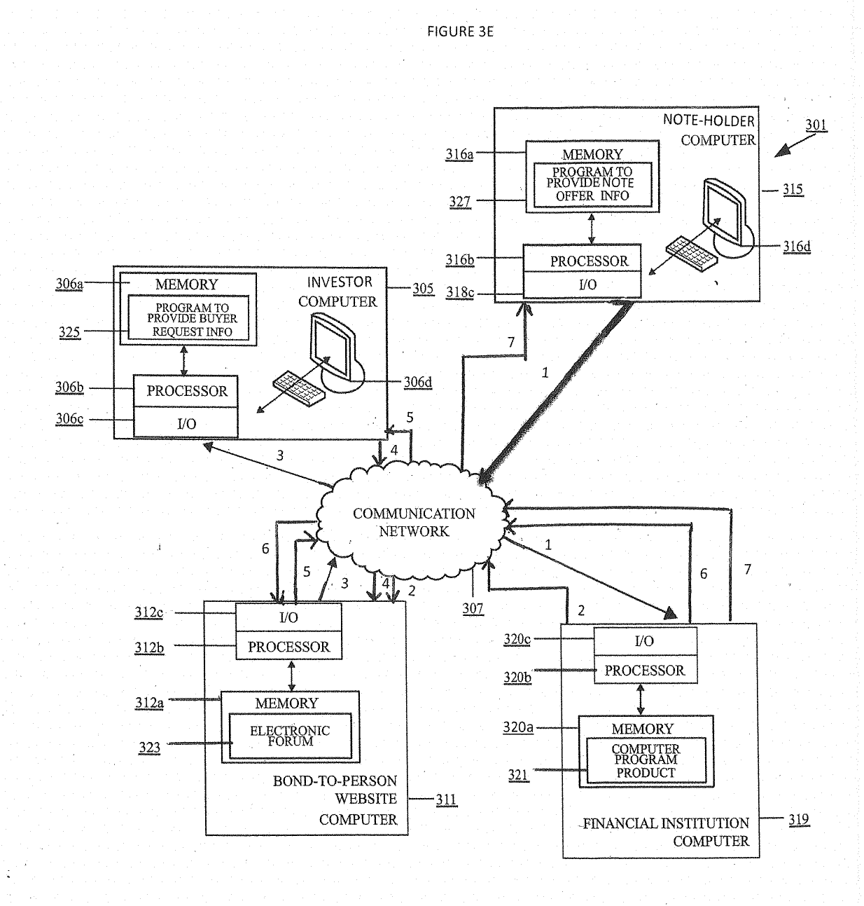

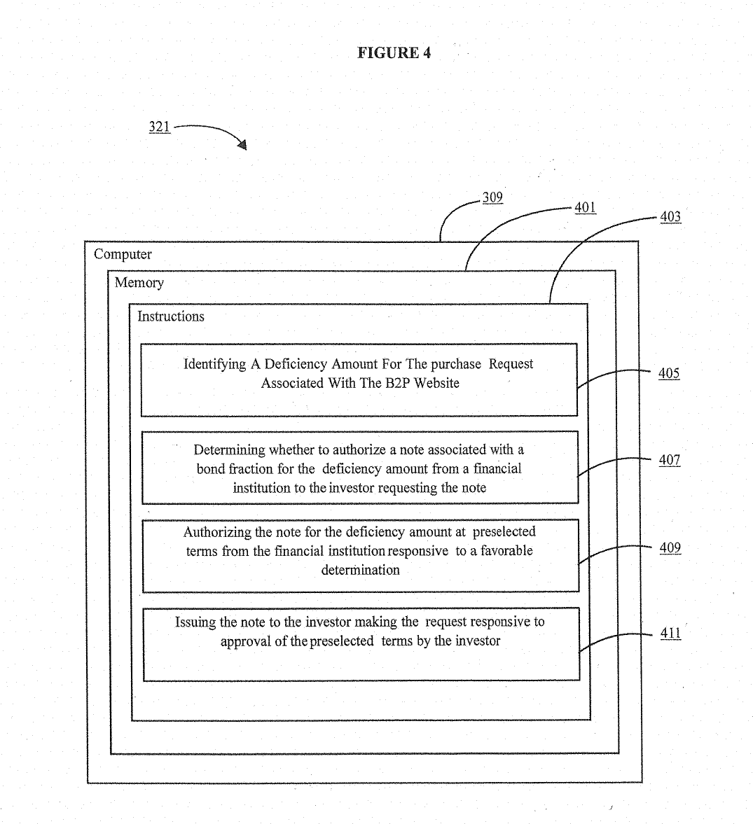

FIGS. 3A and 4 illustrate embodiments which advantageously provide a system 301 to satisfy an investor request associated with a B2P web-site 323. The system 301 includes a first computer associated with an investor defining an investor computer 305. The investor computer 305 can have, for example, memory 306a, one or more processors 306b, input/output (I/O) devices 306c, and a display 306d. The investor computer 305 can also include a program product 325, e.g., software, stored in memory 306a to provide information for a B2P request through an electronic communications network 307, e.g., the Internet or the World Wide Web, to a second computer associated with a B2P web-site 323 defining a B2P web-site computer 311. The B2P web-site computer 311 can have, for example, memory 312a, one or more processors 312b, and input/output (I/O) devices 312c. The B2P web-site computer 311 has an electronic forum 323 for hosting a B2P request and for offers by one or more Note-holders. The Note purchase request information includes a preselected value. Each Note offer associated with the electronic forum 323 is responsive to the B2P investor request and has a value that fulfills all or a portion of the pre-selected Note values.

The system 301 further includes one or more third computers associated with Note-holders defining a Note-holder's computer 315. The Note-holder's computer 315 can have, for example, memory 316a, one or more processors 316b, input/output (I/O) devices 318c, and a display 316d. The Note-holder computer 315 includes a program product 327 stored in memory 316a to provide bond offer information responsive to the B2P bond request to the B2P web-site computer 311 through the electronic communications network 307. That is, an investor can use, for example, a browser or other application program 325 running on a computer 305 to access a B2P web-site computer 311; the investor computer 305 can provide Note request information, as understood by those skilled in the art. Then the investor can use, for example, browsers or other application programs 327 running on computers 315 to access the B2P web-site computer 311; the Note-holders can make offers responsive to the B2P Note request, as understood by those skilled in the art. The computers communicate through the Internet, World Wide Web, or other such electronic communications network 307.

System 301 also, for example, can include a fourth computer associated with a financial institution defining a financial institution computer 319. The financial institution computer 319 can have, for example, memory 320a, one or more processors 320b, and input/output (I/O) devices 320c. The financial institution computer 319 receives request information from the B2P web-site computer 311 through the electronic communications network 307. The financial institution computer 319 includes a computer program product 321 stored on memory 320a.

Illustrated in FIG. 3B is a system in which data flow is initiated by the investor computer 305. Data transmitted by the computers in the system passes through a communications network.

First, the investor computer sends request information to the B2P website computer. Second, the B2P website computer sends aggregate purchase request information to the financial institution computer. Third, the financial institution computer sends a deficiency amount information to the B2P website computer. Fourth, the B2P website computer sends final transaction terms and Note information to the investor computer. Fifth, the B2P website computer sends final transaction terms to the financial institution computer. Optionally, there can be communication with the note holder computer during or after this process.

Illustrated in FIG. 3C is a system in which data flow is initiated by the financial institution computer. Data transmitted by the computers in the system pass through a communications network.

First, the financial institution computer sends sale offer information to the B2P website computer. Second, investor computers send offer acceptance information to the B2P website computer. Third, the B2P website computer sends the final transaction terms and Note information to the investor computer. Fourth, the B2P website computer sends the final transaction terms to the financial institution's computer.

Illustrated in FIG. 3D is a detailed system in which data flow for a transaction is initiated by the investor computer. Data transmitted by the computers in the system passes through a communications network.

First, the note holder computer sends bond availability information to the financial institution computer. Second, the investor computer sends purchase request info to the B2P website computer. Third, the B2P website computer sends purchase request information to the financial institution computer. Fourth, the financial institution's computer sends deficiency amount information to the B2P website computer. Fifth, the B2P website sends deficiency amount information to the investor computer. Sixth, the investor computer sends revised or additional purchase request information to the B2P website computer. Seventh, the B2P website computer sends final Note transaction terms information to the investor computer. Eighth, the B2P website computer sends final bond transaction terms to the financial institution computer. Ninth, the investor computer sends transaction acceptance information to the B2P website computer. Tenth, the financial institution computer sends transaction acceptance information to the B2P website computer. Eleventh, the B2P website computer sends Note ownership information to the investor computer. Twelfth, the financial institution computer sends bond ownership information to the B2P website computer. Finally, the financial institution computer sends bond ownership information to the investor computer.

Illustrated in FIG. 3E is a detailed system in which the data flow is initiated by the financial institution. All the Data transmitted by all the computers in the system passes through a communications network.

First, the note holder computer sends bond availability information to the financial institution computer. Second, the financial institution computer sends sale offer information with final transaction terms information to the B2P website computer. Third, the B2P website computer sends sale offers to the investor computer(s). Fourth, the investor computers sends the offers acceptance information to the B2P website computer. Fifth, the B2P website computer sends Note ownership information to the investors computer(s). Sixth, the financial institution computer sends bond ownership information to the B2P website computer. Finally, the financial institution computer sends bond ownership information to the investor computer(s).

Illustrated in FIG. 4, is a computer program product 321 associated with the financial institution computer 309, stored on a tangible computer memory media 401, operable on a computer, and used to finance an investor request. The computer program product 321, for example, includes a set of instructions 403 that, when executed by the computer 309, cause the computer 309 to perform various operations. The operations include identifying a deficiency amount for the B2P bond request associated with the B2P lending website (block 405). The deficiency amount is the difference between the pre-selected value of the B2P Note request and a value of an aggregate of any investor offers responsive to the B2P Note request.

The operations also include determining whether to authorize a gap-filling Note for the deficiency amount from a financial institution to an investor requesting the Note (block 407) and authorizing the gap filling fractional Note for the deficiency amount at preselected terms from the financial institution (block 409). The operations further include issuing the Note (backed by a fraction of a bond) to the investor making the B2P request responsive to approval of the preselected terms by the investor (block 411).

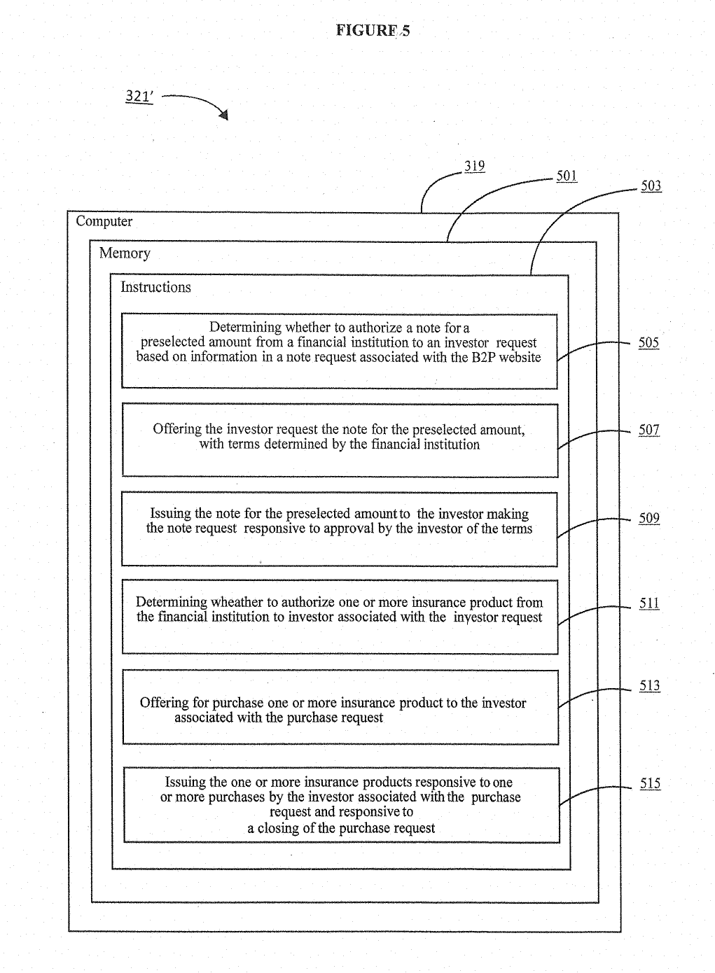

FIG. 5 illustrates another embodiment of a program product which includes a computer program product 321′ associated with a financial institution computer 319, stored on a tangible computer memory media 501, operable on a computer, and used to finance an investor bond request. The computer program product 321′, for example, includes a set of instructions 503 that, when executed by the computer 319, cause the computer 319 to perform various operations. These operations include determining whether to authorize a financial institutional Note for a preselected value from a financial institution to an investor requesting the Note based on information in a B2P Note request (block 505). The operations also include offering to the investor requesting the bond a preselected Note value with terms determined by the financial institution based on the information in the B2P Note request (block 507) so that the investor requesting the Note can choose an immediate Note offer with terms determined by the financial institution or choose to solicit offers with more favorable terms through the B2P web-site. The operations further include issuing the financial institutional Notes for the pre-selected Note values to the investor making the B2P request responsive to approval by the individual investor (block 509). In addition, the operations include determining whether to authorize one or more insurance products from the financial institution to investors associated with the B2P Note request (block 511). The operations further include offering for purchase one or more insurance products (block 513). The operations also include issuing one or more insurance products responsive to one or more purchases by the investors associated with the Note request and responsive to a closing of the Note (block 515).

A person having ordinary skill in the art will recognize that various types of memory are readable by a computer such as described herein, e.g., underwriter computer, bank computer, prepaid card processors, or other computers with embodiments. Examples of computer readable media include but are not limited to: nonvolatile, hard-coded type media such as read only memories (ROMs), CD-ROMs, and DVD-ROMs, or erasable, electrically programmable read only memories (EEPROMs), recordable type media such as floppy disks, hard disk drives, CD-R/RWs, DVD-RAMs, DVD-R/RWs, DVD+R/RWs, flash drives, memory sticks, and other newer types of memories, and transmission type media such as digital and analog communication links. For example, such media can include operating instructions, as well as instructions related to the system and the method steps described above and can operate on a computer. It will be understood, by those skilled in the art, that such media can be at other locations instead of or in addition to the locations described to store program products, e.g., including software, thereon.

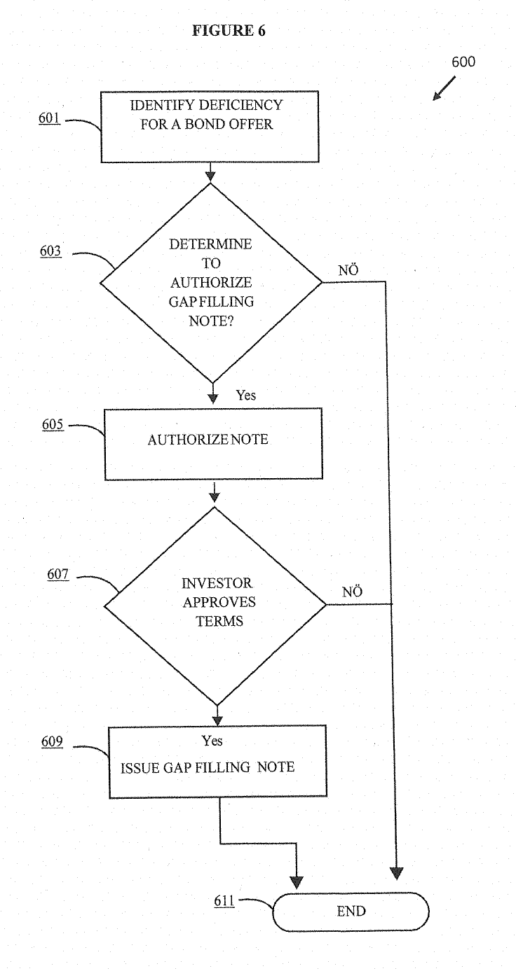

FIG. 6 illustrates an embodiment 600 which includes a process of issuing a gap filling Note from a financial institution, for example. The process includes identifying a deficiency amount for a Note request associated with a B2P web-site (step 601). Next, the decision flow of the process involves determining whether to authorize a gap filling fractional Note for the deficiency amount (block 603). If the determination is not to authorize, the process ends (block 611). If the determination is to authorize, then the financial institution authorizes the gap filling fractional Note (block 605). Next, the decision flow of the process involves asking if the investor approves the terms from the financial institution (block 607). If the investor does not, then the process ends (block 611). If the investor does approve the terms, then the financial institution issues the Note (block 609). And the process ends (block 611).

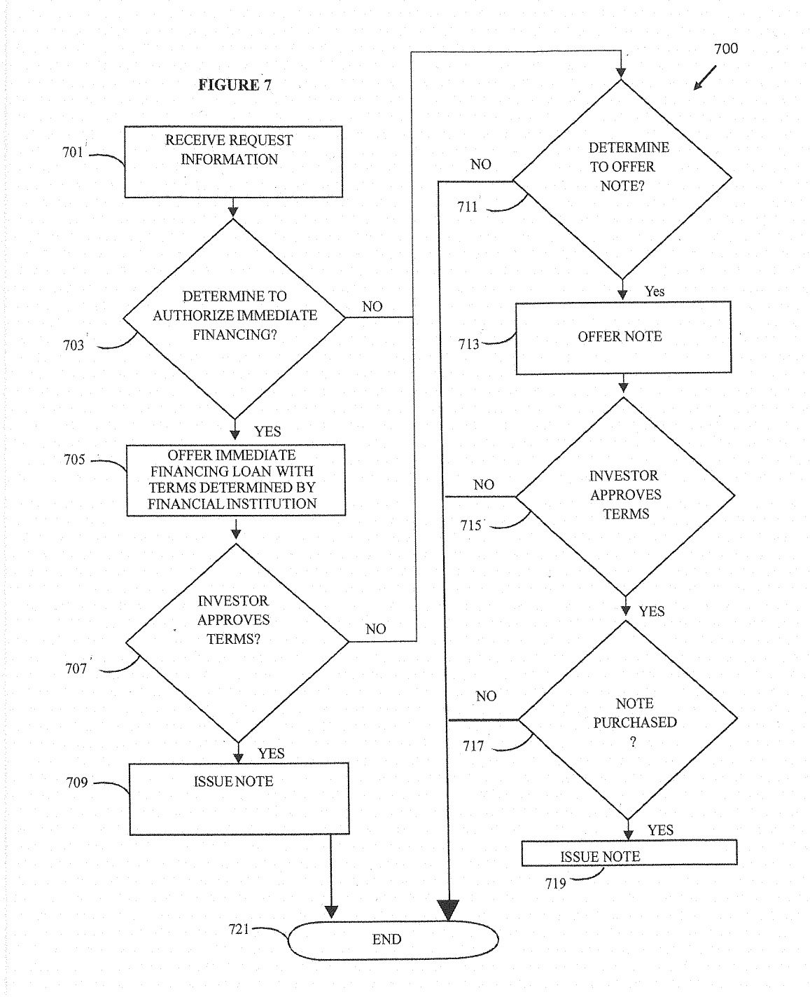

FIG. 7 illustrates another embodiment 700 which includes a process of issuing a loan or insurance product from a financial institution responsive to an investor request. The process includes receiving information in investor requests associated with a B2P web-site (step 701). Next, the decision flow of the process involves determining whether to authorize an immediate financing from the financial institution (block 703). If the determination is to authorize, then the financial institution offers the immediate financing with terms determined by the financial institution (block 705). Next, the decision flow of the process involves asking if the investor approves the terms from the financial institution (block 707). If the investor approves the terms, then the financial institution issues a Note (block 709) and the process ends (block 721). The Note can represent any fraction of a bond or group of bonds. If, however the determination is not to authorize the Note or the investor does not approve terms, then the process continues with determining whether to offer Note insurance products (block 711). If the determination is not to offer the Note insurance products, the process ends (block 721). If the determination is to offer the Note insurance products, then the financial institution offers the Note insurance products (block 713). Next, the decision flow of the process involves asking if the insurance product is purchased (block 715). If the insurance product purchase is declined, then the process ends (block 721). If the insurance product is purchased, then the decision flow of the process involves asking if the Note was purchased (block 717). If the transaction does not close, then the process ends (721). If the transaction does close, then the financial institution issues the Note (block 719). And the process ends (block 721).

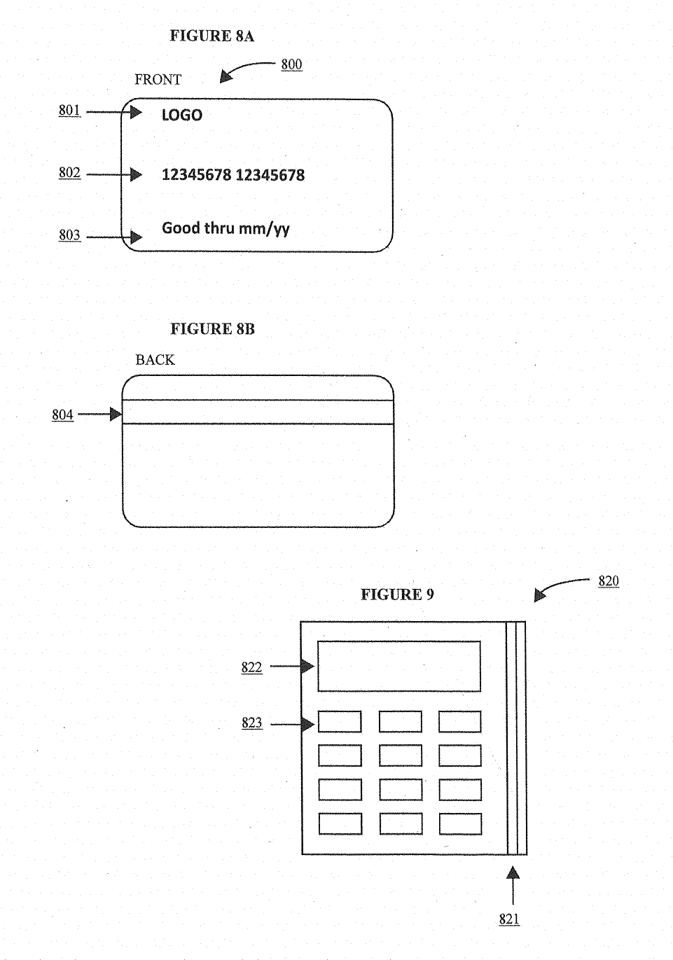

FIGS. 8A and 8B illustrate a prepaid card 800, according to an embodiment. FIG. 9 illustrates a point-of-sale hardware device 820, e.g., a card reader, according to an embodiment. As understood by those skilled in the art, the prepaid card can have indicia 801, e.g., logos, slogans, source identifiers, of a sponsoring bank and of a prepaid card processor; a serial number 802, e.g., an account number; and expiration date 803. The structures of various types of specific cards, e.g., magnetic stripe 804, type of material, are well known to those skilled in the art and can be used with embodiments. Typically, a card 800 is formed from plastic and has a magnetic stripe 804 affixed to the plastic through an application of heat, those skilled in the art will understand that other embodiments besides a magnetic stripe can include radio frequency identification devices (RFID), smart chips, bar codes, and other similar devices. Embodiments can include forming cards or receiving cards already formed. A magnetic stripe card 800 can store information, or data, e.g., account information, by modifying the magnetism of particles on the magnetic stripe 804 on the card. The information can be read by swiping the card with a point-of-sale hardware device 820. The point-of-sale hardware device 820 can include, for example, interface buttons 823 for use by the merchant personnel or the consumer, a display 822 for providing feedback, and a slot 821 for swiping the card to engage the magnetic stripe 804 on the card with the reader as understood by those skilled in the art. Typically, there are two tracks of information on a magnetic card used for financial transactions, known as tracks 1 and 2. In addition, a third track, known as track 3, can be available for magnetic stripe cards. Tracks 1 and 3, if available, are typically recorded at 210 bits per inch, while track 2 typically has a recording density of 75 bits per inch. Track 2, as typically encoded, was developed by the American Bankers Association (ABA) provides for 37 numeric data characters, including up to 19 digits for a primary account number (including a Bank Identification Number as understood by those skilled in the art), an expiration date, a service code, and discretionary verification data, such as, a Personal Identification Number, or PIN. The information on the card can be used, for example, to facilitate a transaction. For example, when the prepaid card 800 is swiped through a point-of-sale device 820, the information on the magnetic stripe 804 is read and processed by the reader allowing a value associated with the prepaid card to be used to purchase goods and services. In addition, the point-of-sale hardware device 820, through its display 822, can represent a visual depiction of the financial institution bond value loaded onto the prepaid card 800.

Advantageously, embodiments can transform data associated with an investor requesting a cash card into data associated with a value on a prepaid card, resulting in the investor being able to, for example, perform a home improvement project, take a vacation, enroll in school, or other such purpose provided by value held in the account.

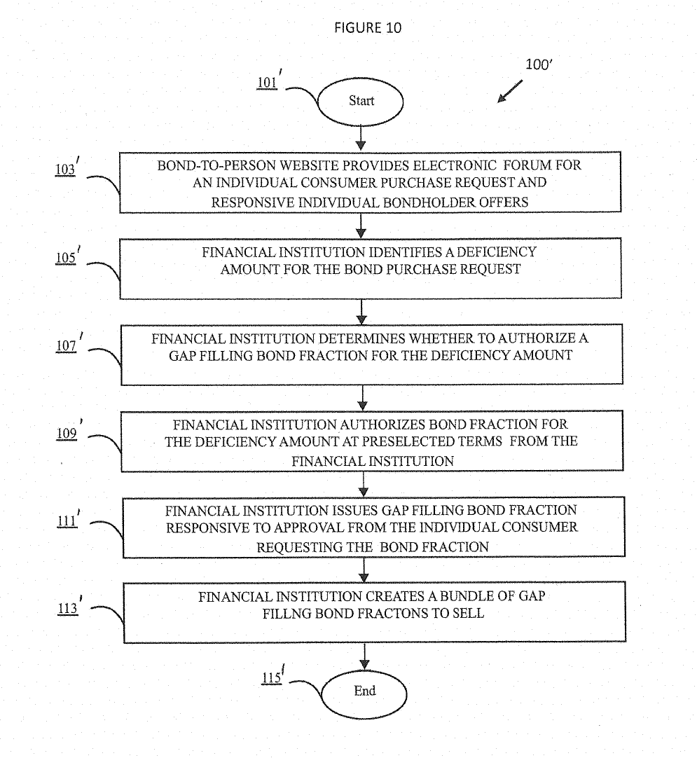

FIG. 10 depicts an overview of one exemplary embodiment. Such embodiments provide computerized methods (100′) of satisfying a bond transaction request associated with a B2P website, and associated systems and program products (block 103′). Embodiments provide for financing a deficiency amount for a B2P transaction request, satisfying a B2P transaction request with a transaction from a financial institution, and guaranteeing a B2P transaction through fractional bond products (block 105′).

The method 100′ starting at block 101′, for example, includes a B2P website providing an electronic forum for a B2P transaction request by a bond buyer and for transaction offers by one or more bond buyers (block 103′). Ideally, each transaction offer is responsive to the B2P transaction request and has a transaction value that fulfills all or a portion of the preselected transaction value. When the full request is not fulfilled, the method also includes identifying a deficiency amount for the B2P transaction request associated with the B2P web-site (block 105′). The deficiency amount is the difference between the preselected transaction value of the B2P transaction request and a value of an aggregate of any bond buyer transaction offers responsive to the B2P transaction request. If the value of the aggregate is less than the preselected transaction value, for example, the method further includes determining whether to authorize a gap filling transaction for the deficiency amount from a financial institution to the bond buyer requesting the transaction (block 107′). Next the financial institution authorizes the gap-filling fractional bond for the deficiency amount at preselected transaction terms from the financial institution (block 109′). The method continues with issuing the gap filling fractional bond to the bond buyer making the B2P transaction request responsive to approval of the preselected terms by the bond buyer (block 111′). The method further includes the financial institution creating a collection of a plurality of B2P transactions to define a bundle of B2P transactions to sell, in which a bundle includes one or more gap filling transactions (block 113′). The method ends at block 115′.

As understood by those skilled in the art, the financial institution serves as stop-gap for bond requests that are not fully satisfied but meet the financial institution's strategy, fulfilling the uncommitted portion of the transaction requests. Benefits over prior art methods include, for example, a significant increase in transaction closings as otherwise unsatisfied transaction requests gain a second opportunity, more options for a blended rate for bond buyer customers, and additional pressure on bond buyer bond holders due to the financial institution involvement, as understood by those skilled in the art. Moreover, the sale of transactions, for example, gap filling transactions, in a collection, bundle, or pool can reduce risk through diversification and can make, for example, otherwise minor and uneconomical investments of sufficient worth for interest by secondary capital markets, as understood by those skilled in the art. Thus, the embodiments disclosed are supplements in addition to a B2P website.

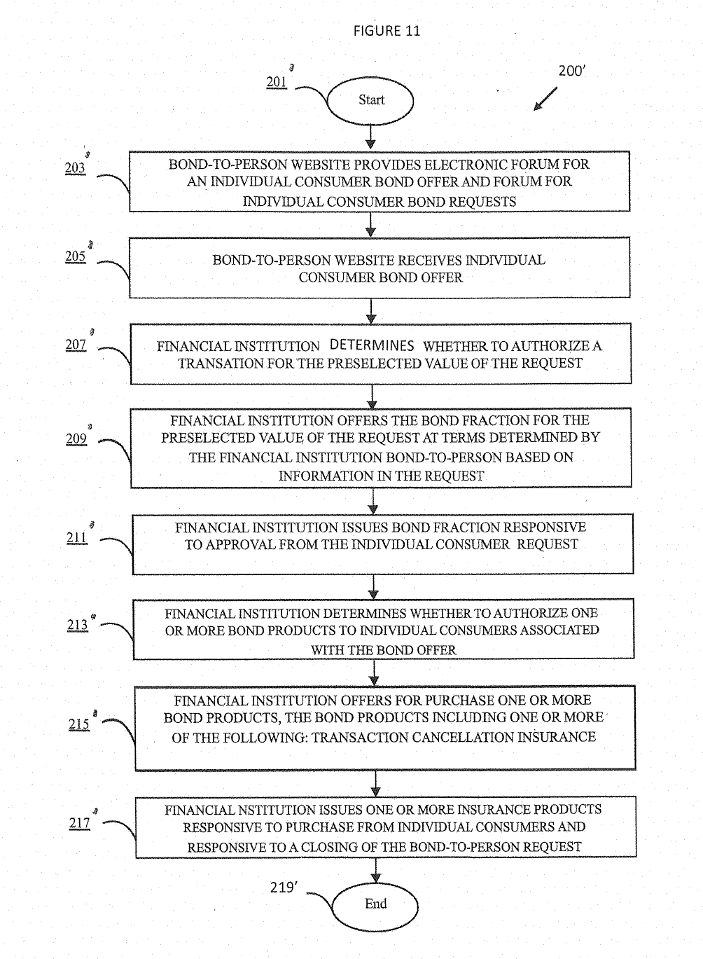

FIG. 11 illustrates another embodiment of a method 200′ starting at block 201′, which, for example, provides a computer-implemented method of satisfying a bond request. The computer-implemented method includes a B2P bond website providing an electronic forum for B2P transaction requests by a bond buyer and for transaction offers by one or more bond buyers (block 203′). The transaction request has a preselected transaction value. Each transaction offer made is responsive to the B2P transaction request and has a transaction value that fulfills all or a portion of the preselected transaction value (block 205′). The computer implemented method also includes receiving the B2P transaction request, the transaction request includes information about the bond buyer making the B2P transaction request, as understood by those skilled in the art. The computer-implemented method further includes a financial institution determining whether to authorize a financial institutional transaction for the pre-selected transaction value to the bond buyer making the B2P transaction request based on the information in the B2P transaction request (block 207′). The computer-implemented method continues with the financial institution offering the financial institutional transaction for the pre-selected transaction value at transaction terms determined by the financial institution based on information in the B2P transaction request. Such allows the bond buyer requesting the transaction to choose an immediate transaction offer with terms determined by the financial institution or choose to solicit bond buyer transaction offers with more favorable terms through the B2P bond website (block 209′). The computer-implemented method further includes issuing the financial institutional transaction responsive to approval by the bond buyer requesting the transaction of the terms from the financial institution (block 211′). In addition, the computer-implemented method includes the financial institution determining whether to authorize one or more fractional bond products to bond buyers associated with the B2P transaction request (block 213′). The computer-implemented method continues with the financial institution offering for purchase one or more insurance products to the bond buyers associated with the bond request (block 215′). The fractional bond products include one or more of the following: default insurance and transaction cancellation insurance, as understood by those skilled in the art. The computer-implemented method also includes issuing one or more fractional bond products responsive to a purchase from bond buyers and responsive to a closing of the transaction (block 217′). The method ends at block 219′.

As understood by those skilled in the art, the immediate financing option provided by the financial institution can guarantee transaction funding (assuming the consumer is willing to accept the terms of the financial institution) and establishes a ceiling on the “zone of possible agreement.” Other benefits of immediate financing embodiments, i.e., prior to a transaction auction, and gap filling transaction embodiments, i.e., after a transaction auction, especially in combination when the consumer is effectively pre-qualified for the gap filling transaction, include an increase in transaction closings and an increase in the availability of a blended rate for the consumer. A blended rate may or may not exceed the desired rate (yield) or a maximum rate of the B2P transaction request, as understood by those skilled in the art. The availability of fractional bond products can reduce bond holder risk, improve the comfort level of a bond holder with respect to repayment, and provide assurance to a bond holder, resulting in a greater willingness to enter into transactions, as understood by those skilled in the art.

According to other embodiments, the financial institution can be a federally chartered broker subject to security laws and regulations and not subject to state laws and regulations. Therefore, the federally chartered financial institution enjoys rate preemption; that is, state licensing requirements are preempted and do not apply to the federally chartered financial institution. As understood by those skilled in the art, a federally chartered financial institution can operate in every state with a consistent implementation nationally rather than a state-by-state approach and can charge any rate for the gap filling transactions or immediate financing transactions without regard to state law.

Embodiments include additional features, as will be understood by those skilled in the art. The financial institution, for example, can employ various levels of sophisticated underwriting models and preselected authorization parameters to determine whether to authorize a gap filling transaction, a financial institutional transaction for the entire selected transaction value, and one or more fractional bond products to guarantee the transaction, according to embodiments, so that transaction request data is converted into transaction offer data. Based on information from the credit reporting agencies that individual bond holders on the B2P site would not otherwise have access to or the sophistication to develop, such models, for example, may include a behavior a rating score that considers the consumer's credit score, length of employment, the presence of recent derogatory credit information such as bankruptcy, ability to provide direct deposits to the financial institution, or direct deposit history.

Embodiments provide other benefits to the B2P website. An association with the financial institution can legitimize the B2P website, as understood by those skilled in the art. The addition of gap filling transactions, according to the embodiments, allows the B2P website to preserve its social feel with the financial institution serving simply as a backstop for both bond buyer consumers and bond holders. Also, reporting the financial institution performance, as understood by those skilled in the art, for example, can create a “Beat the Stuffy, White Shirt Bond Broker” promotional opportunity for the B2P website.

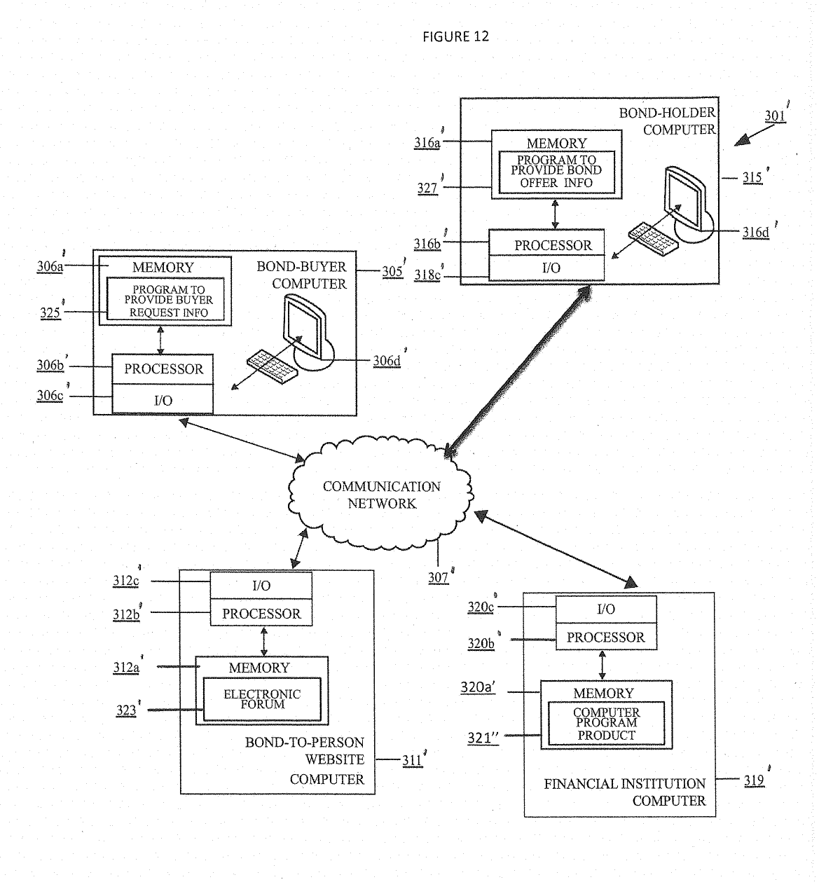

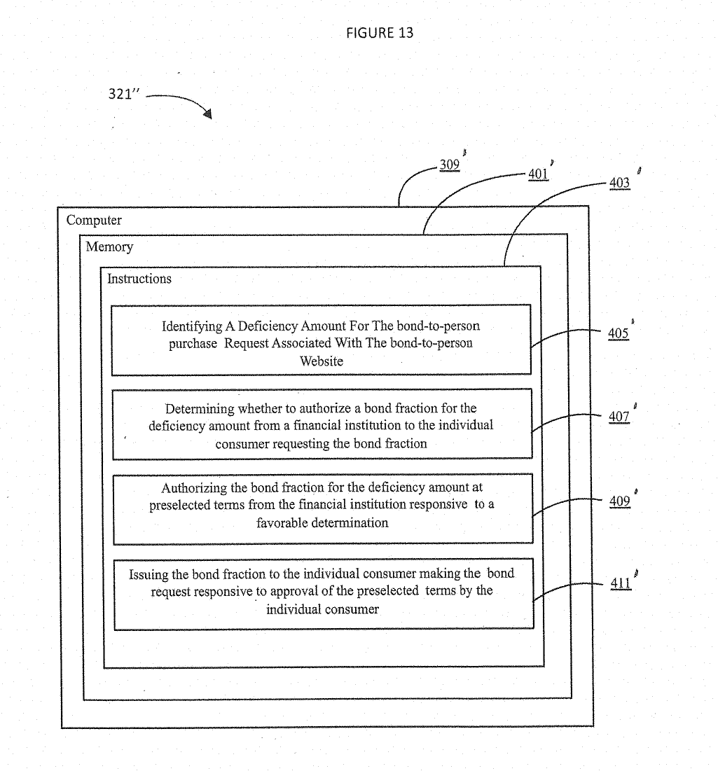

FIGS. 12 and 13 illustrate embodiments which advantageously provide a system 301′ to satisfy a bond buyer bond request associated with a B2P web-site 323′. The system 301′ includes a first computer associated with a bond buyer defining a bond buyer computer 305′. The bond buyer computer 305′ can have, for example, memory 306a′, one or more processors 306b′, input/output (I/O) devices 306c′, and a display 306d′. The bond buyer computer 305′ can also include a program product 325′, e.g., software, stored in memory 306a′ to provide information for a B2P request through an electronic communications network 307′, e.g., the Internet or the world-wide web, to a second computer associated with a B2P web-site 323′ defining a B2P web-site computer 311′. The B2P web-site computer 311′ can have, for example, memory 312a′, one or more processors 312b′, and input/output (I/O) devices 312c′. The B2P lending web-site computer 311 has an electronic forum 323′ for hosting a B2P request and for bond offers by one or more bond holders. The bond purchase request information includes a preselected value. Each bond offer associated with the electronic forum 323′ is responsive to the B2P bond request and has a value that fulfills all or a portion of the pre-selected bond values.

The system 301′ further includes one or more third computers associated with bond holders defining a bond holder's computer 315′. The bond holder's computer 315′ can have, for example, memory 316a′, one or more processors 316b′, input/output (I/O) devices 318c′, and a display 316d′. The bond holder computer 315′ includes a program product 327′ stored in memory 316a′ to provide bond offer information responsive to the B2P bond request to the B2P web-site computer 311′ through the electronic communications network 307′. That is, a bond buyer borrower can use, for example, a browser or other application program 325′ running on a computer 305′ to access a B2P web-site computer 311′; the borrower computer 305′ can provide bond request information, as understood by those skilled in the art. Then the bond buyer bond holders can use, for example, browsers or other application programs 327′ running on computers 315′ to access the B2P web-site computer 311′; the bond holders can make offers responsive to the B2P bond request, as understood by those skilled in the art. And the computers all communicate through the Internet, World Wide Web, or other such electronic communications network 307′.

The system 301′ also, for example, can include a fourth computer associated with a financial institution defining a financial institution computer 319′. The financial institution computer 319′ can have, for example, memory 320a′, one or more processors 320b′, and input/output (I/O) devices 320c′. The financial institution computer 319′ receives request information from the B2P web-site computer 311′ through the electronic communications network 307′. The financial institution computer 319′ includes a computer program product 321″ stored on memory 320a′.

Illustrated in FIG. 13, is a computer program product 321″ associated with the financial institution computer 309′, stored on a tangible computer memory media 401′, operable on a computer, and used to finance a bond buyer request. The computer program product 321″, for example, includes a set of instructions 403′ that, when executed by the computer 309′, cause the computer 309′ to perform various operations. The operations include identifying a deficiency amount for the B2P bond request associated with the B2P lending website (block 405′). The deficiency amount is the difference between the pre-selected bond value of the B2P bond request and a value of an aggregate of any bond buyer bond offers responsive to the B2P bond request, if the value of the aggregate is less than the preselected bond value.

The operations also include determining whether to authorize a gap-filling fractional bond for the deficiency amount from a financial institution to a bond buyer requesting the bond (block 407′) and authorizing the gap filling fractional bond for the deficiency amount at preselected bond terms from the financial institution (block 409′). The operations further include issuing the gap filling fractional bond to the bond buyer making the B2P request responsive to approval of the preselected terms by the bond buyer (block 411′).

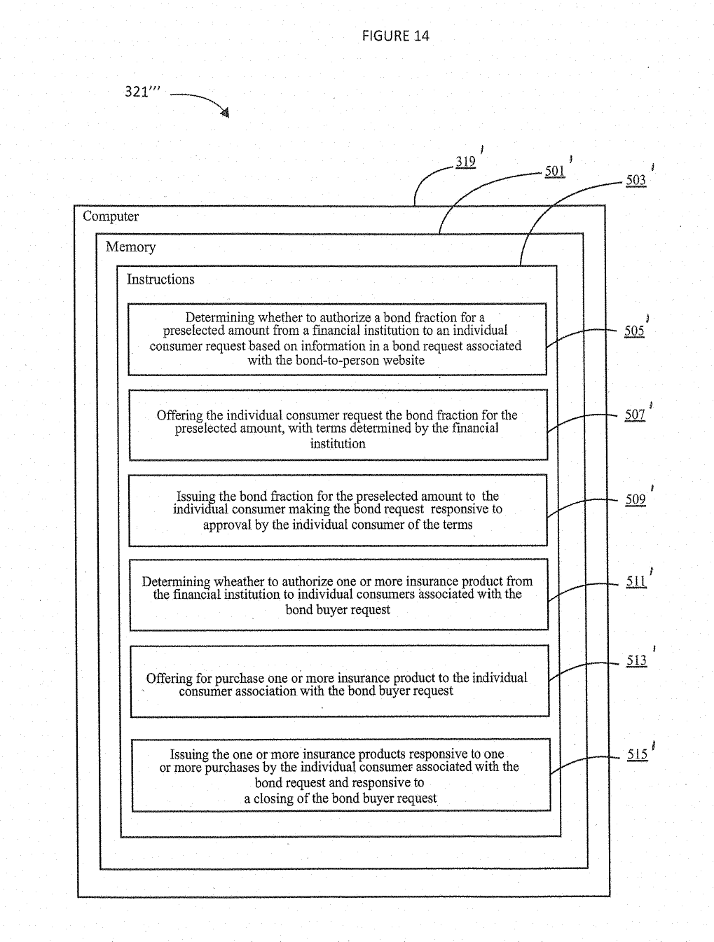

FIG. 14 illustrates another embodiment of a program product which includes a computer program product 321′″ associated with a financial institution computer 319′, stored on a tangible computer memory media 501′, operable on a computer, and used to finance a bond-buyer's bond request. The computer program product 321′″, for example, includes a set of instructions 503′ that, when executed by the computer 319′, cause the computer 319′ to perform various operations. These operations include determining whether to authorize a financial institutional fractional bond for a preselected value from a financial institution to a bond buyer requesting the bond based on information in a B2P bond request (block 505′). The operations also include offering to the bond buyer requesting the financial institutional bond for the preselected bond with bond terms determined by the financial institution based on the information in the B2P bond request (block 507′) so that the bond buyer requesting the bond can choose an immediate bond offer with terms determined by the financial institution or choose to solicit bond holder offers with more favorable terms through the B2P website. The operations further include issuing the financial institutional bond for the pre-selected bond value to the bond buyer making the B2P bond request responsive to approval by the individual bond buyer of the terms from the financial institution (block 509′). In addition, the operations include determining whether to authorize one or more insurance products from the financial institution to bond buyers associated with the B2P bond request (block 511′). The operations further include offering for purchase one or more insurance products such as, for example, transaction cancellation insurance (block 513′). The operations also include issuing one or more insurance products responsive to one or more purchases by the bond buyers associated with the B2P bond request and responsive to a closing of the bond (block 515′).

A person having ordinary skill in the art will recognize that various types of memory are readable by a computer such as described herein, e.g., underwriter computer, bank computer, prepaid card processors, or other computers. Examples of computer readable media include but are not limited to: nonvolatile, hard-coded type media such as read only memories (ROMs), CD-ROMs, and DVD-ROMs, or erasable, electrically programmable read only memories (EEPROMs), recordable type media such as floppy disks, hard disk drives, CD-R/RWs, DVD-RAMs, DVD-R/RWs, DVD+R/RWs, flash drives, memory sticks, and other newer types of memories, and transmission type media such as digital and analog communication links. For example, such media can include operating instructions, as well as instructions related to the system and the method steps described above and can operate on a computer. It will be understood, by those skilled in the art, that such media can be at other locations instead of or in addition to the locations described to store program products, e.g., including software, thereon.

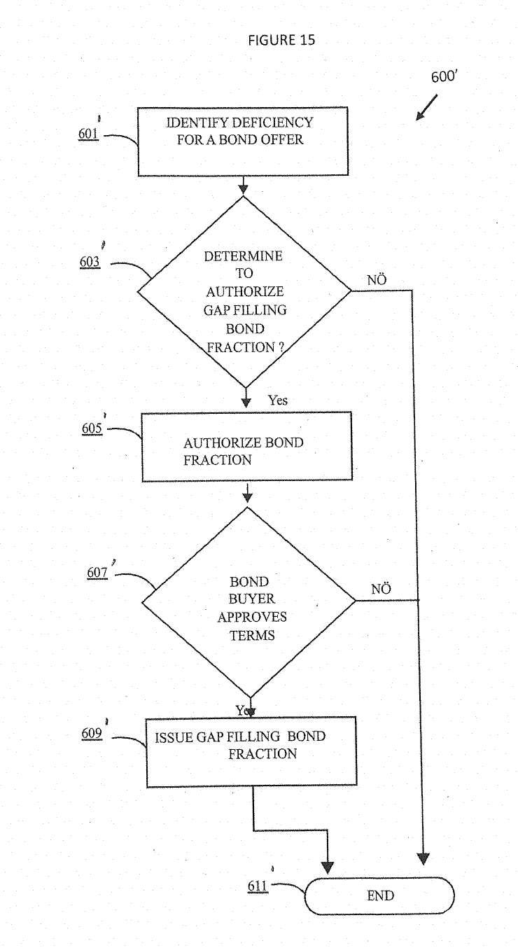

FIG. 15 illustrates an embodiment 600′ which includes a process of issuing a gap filling bond from a financial institution, for example. The process includes identifying a deficiency amount for a bond request associated with a B2P web-site (step 601′). Next, the decision flow of the process involves determining whether to authorize a gap filling fractional bond for the deficiency amount (block 603′). If the determination is not to authorize, the process ends (block 611′). If the determination is to authorize, then the financial institution authorizes the gap filling fractional bond (block 605′). Next, the decision flow of the process involves asking if the bond buyer approves the terms from the financial institution (block 607′). If the bond buyer not, then the process ends (block 611′). If the bond buyer does approve the terms, then the financial institution issues the bond (block 609′). And the process ends (block 611′).

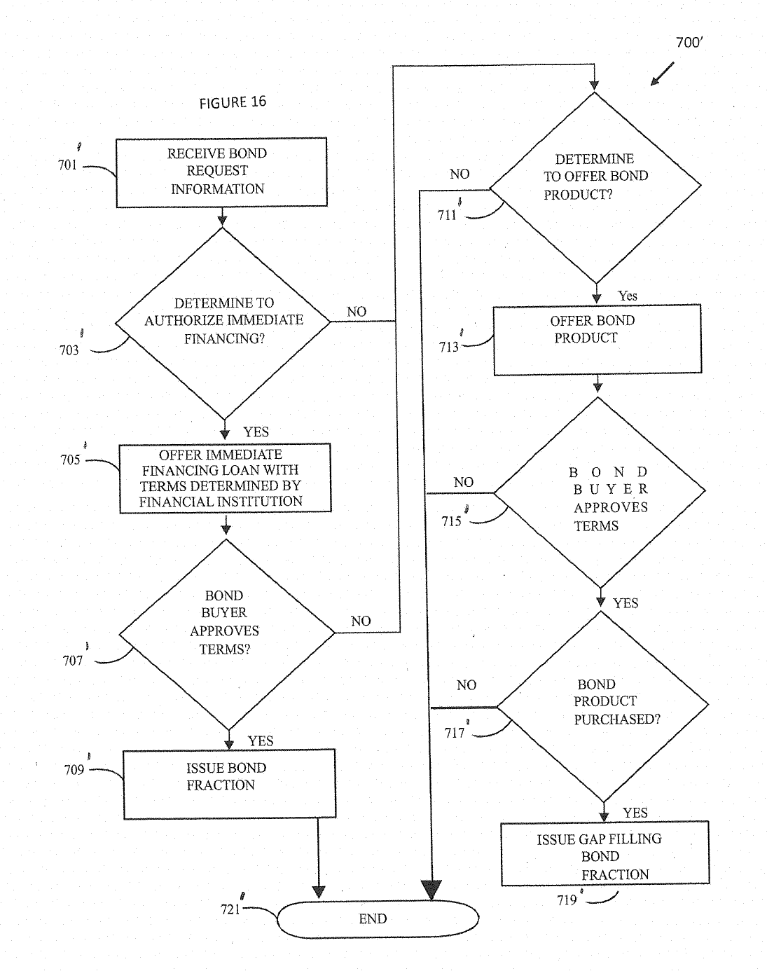

FIG. 16 illustrates another embodiment 700′ which includes a process of issuing a bond or insurance product from a financial institution responsive to a B2P bond request. The process includes receiving information in person-to-person bond requests associated with a B2P web-site (step 701′). Next, the decision flow of the process involves determining whether to authorize an immediate financing from the financial institution (block 703). If the determination is to authorize, then the financial institution offers the immediate financing with terms determined by the financial institution (block 705′). Next, the decision flow of the process involves asking if the borrower approves the terms from the financial institution (block 707′). If the borrower approves the terms, then the financial institution issues a bond (block 709′) and the process ends (block 721′). The bond can represent any fraction of a bond or group of bonds. If, however the determination is not to authorize the bond or the borrower does not approve terms, then the process continues with determining whether to offer bond insurance products (block 711′). If the determination is not to offer the bond insurance products, the process ends (block 721′). If the determination is to offer the bond insurance products, then the financial institution offers the bond insurance products (block 713′). Next, the decision flow of the process involves asking if the insurance product is purchased (block 715′). If the insurance product purchase is declined, then the process ends (block 721′). If the insurance product is purchased, then the decision flow of the process involves asking if the bond was purchased (block 717′). If the transaction does not close, then the process ends (721′). If the transaction does close, then the financial institution issues the bond (block 719′). And the process ends (block 721′).

Embodiments can provide additional benefits for the financial institution, including a low-cost investor acquisition channel and cross-marketing opportunities for other products and services, as understood by those skilled in the arts, the financial institution can purchase receivables from the investors, forming a secondary market and providing Note-holders the ability to access cash tied up in bonds. Additionally, the financial institution can share its sophisticated underwriting models and preselected authorization parameters with Note-holders wanting to piggyback on the financial institution's credit standards according to embodiments, further legitimizing the B2P web-site and the underwriting and performance data reported by the B2P web-site, as understood by those skilled in the arts.

Many modifications and other embodiments will come to the mind of one skilled in the art having the benefit of the teachings presented in the foregoing descriptions and the associated drawings. Therefore, it is to be understood that the disclosure is not to be limited to the illustrated embodiments described here and that modifications and other embodiments are intended to be included within the scope of the appended claims.

While the foregoing written disclosure enables one of ordinary skill to make and use the methods and systems herein, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the disclosure as claimed.

What is claimed is:

1. A method comprising:
obtaining investor specific transaction information for a first investor and a second investor from an electronic forum for requesting an investment transaction involving a structured financial note;
comparing, by a processor, the obtained investor specific transaction information with pre-determined financial institution acceptance criteria to determine whether to authorize transactions with the first investor and the second investor, by
reading, by an automated program, the investor specific transaction information and sorting the information into transaction request information and investor qualifications information,
identifying a deficiency amount from the transaction request information for the first and second investors, and
analyzing the investor qualifications information to determine if the investor's qualifications meet or exceed the pre-determined financial institution acceptance criteria, and
determining whether to authorize sale of a first fraction of the structured financial note to the first investor, and a second fraction of the structured financial note to the second investor, at pre-selected terms from the financial institution when the analysis of the first investor qualifications information and the second investor qualifications information meets or exceeds the pre-determined financial institution acceptance criteria.

2. The method of claim 1, further comprising transmitting to the first and second investors offers for transactions having preselected transaction values prior to transaction data being posted on the electronic forum so that the first and second investors can opt to select an immediate transaction offer with terms determined by a financial institution.

3. The method of claim 1, wherein the deficiency amount is the difference between the pre-selected transaction value of the transaction request and a value of an aggregate of any investor transaction offers responsive to the transaction request and associated with the electronic forum, the value of the aggregate being less than the preselected transaction value; and the method further comprises offering to at least one of the first investor and the second investor a gap filling transaction from a financial institution for the deficiency amount having transaction terms determined by the financial institution.

4. The method of claim 1, further comprising issuing a first fraction of the structured financial note to the first investor, and a second fraction of the structured financial note to the second investor.

5. The method of claim 1, wherein the structured financial note comprises at least one member selected from the group consisting of fractional credit products, fractional insurance products and fractional bond products.

6. The method of claim 4, wherein the step of issuing a first fraction of the structured financial note includes loading the transaction value to a prepaid card to thereby convert the transaction request into a prepaid card having an associated value and being capable of purchasing at least one of goods and services.

7. The method of claim 6, further comprising reading data on the prepaid card to access the transaction value on the prepaid card to represent a visual depiction of the transaction value on a display associated with the reader, and to complete a transaction of goods to convert the data on the prepaid card into goods.

8. The method of claim 1, wherein the electronic forum solicits transaction requests having a minimum interest rate and responsively solicits transaction offers having an interest rate, the transaction offer interest rate being greater than or equal to the transaction request minimum interest rate so that multiple investors can compete to fulfill the transaction request.

9. A method comprising:
receiving at least first and second fractional structured financial note purchase requests from first and second remote purchase request computer terminals and displaying them on a website,
receiving an approved deficiency amount from a structured financial note broker from a broker remote computer terminal for a structured financial note sale and displaying it on a website,
determining whether to complete a structured financial note transaction based upon whether an aggregate of structured financial note purchase requests meets the terms of sale based on data received from the broker remote computing terminal,
transmitting final terms of the structured financial note transaction to the broker remote computer terminal, and
transmitting final terms of fractional portions of the structured financial note transaction to the first and second remote purchase request computer terminals.

10. The method of claim 9, further comprising facilitating the purchase of fractional structured financial notes by sending information to, and receiving information from the first and second remote purchase request computer terminals and the broker remote computer terminal.

11. The method of claim 9, further comprising sending information to and receiving information from a financial institution computer, wherein the financial institution guarantees the fractional structured financial note sale.

12. The method of claim 11, wherein the financial institution delegates authorization of the purchase of fractional structured financial notes to a service provider.

13. A method comprising
receiving a fractional structured financial note sale offer from a structured financial note broker remote computer terminal,
displaying a fractional structured financial note sale offer on a website,
receiving information from at least first and second buyers through first and second remote computer terminals indicating that the buyers accept fractional structured financial note sale offers,
determining whether to complete a structured financial note transaction based upon whether an aggregate of buyers that accept the terms of the sale offer is sufficient according to the terms of the sale offer based upon data received from the broker remote computing terminal,
transmitting final terms of the structured financial note transaction to the structured financial note broker remote computer terminal, and
transmitting final terms of the fractional structured financial note sale to the first and second remote computer terminals.

14. The method of claim 13, further comprising executing the fractional structured financial note sale immediately after transmitting the final terms of sale.

15. The method of claim 13, wherein the method further comprises facilitating the closing of a transaction between the structured financial note broker and buyers.

16. The method of claim 13, where the terms of the fractional structured financial note sale first offer are pre-negotiated with the structured financial note broker by a first service provider.

17. The method of claim 13 in which the terms of the immediate fractional structured financial note sale offer are determined by the structured financial note broker.

18. The method of claim 13, further comprising sending information to and receiving information from a financial institution computer, wherein the financial institution guarantees the fractional structured financial note sale.

19. The method of claim 18, wherein the financial institution delegates authorization of the purchase of fractional structured financial notes to a second service provider.

20. A system for selling fractional structured financial notes to buyers, the system comprising:
a central computer configured to:
receive data indicative of at least one fractional structured financial note purchase request from at least first and second buyer remote computing terminals,
receive data indicative of a transaction deficiency amount from a broker remote computing terminal,
determine whether the aggregate of purchase requests received fulfills the terms of a transaction deficiency amount,
transmit data indicative of transaction details to the first and second buyer remote computing terminals and the broker remote computing terminal, and
facilitate data transfer between the first and second buyer computing terminals and the central computer, and the structured financial note holder computer terminal and the central computer.

21. The system of claim 20, further comprising executing a sale of fractional structured financial notes immediately after transmitting the final terms of the sale.

22. A computer program product for selling fractions of a structured financial note to buyers, the computer program product comprising:
one or more computer readable storage media, and
program instructions stored on the one or more computer readable storage media, the program instructions comprising:
program instructions to receive investor data from a plurality of investors, wherein the investor data includes investor specific transaction information, and
program instructions to receive financial institution data from a financial institution for the structured financial note to be sold to at least a portion of the plurality of investors,
responsive to receiving investor data and financial institution data, program instructions to determine an investor group using an algorithm which determines:
which of the plurality of investors meet the investor qualifications for the transaction, and
the fractional amount of the structured financial note to be sold to each investor, and
program instructions to transmit transaction data to investors.

23. The computer program product of claim 22, further comprising program instructions to receive payments from investors and transmit data to investors indicative of fractional ownership of the structured financial note.
